(19) United States
(12) Patent Application Publication
(10) Pub. No.: US 2010/0317401 A1
(43) Pub. Date: Dec. 16, 2010

(54) Method, apparatus, and system for transferring data between mobile telephones and other digital devices

(76) Inventors: Randy C. Lee, Mountain View, CA (US); James C. Patton, Salinas, CA (US); Thomas J. Beck, Los Gatos, CA (US)

Correspondence Address: DAVID LEWIS, 1250 AVIATION AVE., SUITE 200B, SAN JOSE, CA, 95110, US

(21) Appl. No.: 11/235,562

(22) Filed: Sep. 27, 2005

Related U.S. Application Data
(63) Continuation-in-part of application No. 11/105,301, filed on Apr. 14, 2005, now abandoned.

(51) Int. Cl. H04W 88/04; H04M 1/00; G06F 13/38; G06F 9/44

(52) U.S. Cl. 455/557; 710/62; 710/19; 717/173

(57) ABSTRACT

The improved method, apparatus and system of the present invention provide a means for users to transfer data from and to a cell phone memory using a plurality of data transfer methods. The apparatus of the present invention comprises a low complexity digital device having two I/O (Input/Output) connectors, one for the user's cell phone and one for connecting to some other device such as a PC. Central to the apparatus of the present invention is an Inter-device Data Transfer Processor (IDTP) which contains the necessary hardware and software to automatically move the data contents of a cell phone memory to one of a plurality of external digital devices.

This non-provisional utility patent application is a continuation-in-part of currently pending application Ser. No. 11/105,301 filed Apr. 6, 2005.

### BRIEF DESCRIPTION

The subject of this invention relates to the communications industry. Specifically, the present invention is directed to mobile telephones and more particularly to improvements in the ability to transfer data to and from a mobile telephone memory to some other digital device using a plurality of data transfer methods. Examples of such data include phone number directories and pictures, among others.

### BACKGROUND OF THE INVENTION

Mobile telephones have been in existence for some time. Initially, these devices were limited to audio messaging typical of telephony communications. More recently other services and functions have emerged for use on mobile, or cellular telephones. These services include text messaging, pictures, GPS location and Internet browsing.

One consequence of these emerging services, driven by both accelerating and merging technology, is the need for users to update their equipment. This trend has been exacerbated by cellular service providers who offer incentives to upgrade. Of course the reason for this is to encourage the user to spend more time on the air, thus increasing the revenue of the service provider, but one result is that a user will have certain data stored on his/her present cell phone that will need to be transferred to a the new phone or, more likely, have to be reentered.

Although some cellular service providers currently provide a method for accomplishing such a data transfer, the solution is specific to a device and typically performed only at a provider's store. Thus if the user upgrades or changes to a non-compatible device, the transfer method is useless. Each of the plethora of cell phone manufacturers provides unique connections to their phones, both physical and electrical. Thus while a user may buy a newer phone from the same manufacturer, the interconnect method will likely be different, again rendering the data transfer method useless.

Also present in the prior art are solutions that enable a user to backup their cell phone data to the cellular service providers network which over time is very expensive to the consumer because of the repeating monthly service charge and once using the service, locks in the consumer with that particular service provider. Other solutions include software and cable solutions that are PC centric and difficult to use because of the non-standard cell phone driver requirements needed to run software on a PC, for example SnapSync™ from FutureDial, Sunnyvale, Calif., and other devices such as the Mobile Whiz from i.Tech Dynamic Limited, Hong Kong, because of the products limited features, network specific cell phone support (GSM cell phone only), and non-functional form factor. Each of these has limitations. For example, backing up to a network diminishes the portability of the data and requires a network capable cell phone. In some cases, the network that is used is not compatible with others phones or networks, severely limiting viability of data back-up. A further limitation is that some solutions, for example, getGOING™, from Verizon Wireless, Bedminster, N.J., depend on the availability of a digital wireless signal. Without such a signal the solution is useful only in a limited area. With the use of network solutions as well as the other solutions above, data portability and ease of use remains a problem.

A further problem with the prior art is that there is no way to simply back up the data contained in the cell phone memory. Thus if the user drops the phone and breaks it, or, as is sometimes the case, simply looses the device, all the data contained in the cell phone memory is lost. Contemporary digital devices such as PCs, MP3 players and PDAs all have a method for storing data in an external medium to protect against such exigencies. One solution to this problem is presented in co-pending U.S. application Ser. No. 11/105,301, filed Apr. 6, 2005 by Tavonni Technologies, Inc. of San Jose, Calif. The subject matter presented in this application solves many of the problems mentioned just above, but lacks certain other features that greatly improve the user's experience and extends the life of their cell phone. These features include such things as flexible upgrade paths via modifiable hardware platforms, a plurality of data transfer methods, and embedded device ID for enhanced security and enhanced functionality and capabilities.

Because of the rather large number of cell phone manufacturers, coupled to the even wider variety of interconnect configurations, users who are upgrading or changing equipment are at a distinct economic and functional disadvantage. This is so since they will necessarily have to purchase the requisite accessories as well as the phone. What is needed is a method and apparatus whereby a user can make a single purchase of an accessory that will adapt to a plurality of cell phones, allowing them to reuse the transfer capability again and again thereby providing a significant functional advantage to the consumer.

What would be even more advantageous would be a method and apparatus that allowed the transfer of data from a cell phone to some other digital device, for example a PDA (Personal Digital Assistant) or PC (Personal Computer) for the purpose of editing the cell phone data. In this way the user could manipulate data on a plurality of local digital devices rather than a PC only. The capability to manipulate the data from a cell phone in an external medium provides the additional advantage of allowing for ease of data addition and/or correction.

Even further, it would be advantageous to the user to be able to transfer data via a multitude of systems and methods. For example, transfer of data over the Internet, using a PC, or from one cell phone to another cell phone directly. One novel feature of the improved method of the present invention is the ability to upgrade a user's software over the Internet using the transfer of data over the Internet.

The improved method, apparatus and system of the present invention provide a number of improvements over the prior art including, among others, allowing a cell phone user to transfer the data contents of a cell phone to a PC for editing. Several advantages derive from the present invention as discussed in detail below.

### SUMMARY OF THE INVENTION

The improved method, apparatus and system of the present invention provide a means for users to transfer data from and to a cell phone memory using a plurality of data transfer methods. The apparatus of the present invention comprises a low complexity digital device having two I/O (Input/Output) connectors, one for the user's cell phone and one for connecting to some other device such as a PC. Central to the apparatus of the present invention is an Inter-device Data Transfer Processor (IDTP) which contains the necessary hardware and software to automatically move the data contents of a cell phone memory to one of a plurality of external digital devices.

The method of the present invention provides a process for transferring data from a cell phone to a PC or to some other storage device, for example, to a host device such as a server, or to another cell phone. The method allows a user to edit cell phone content directly on the cell phone or, alternatively, to interface the apparatus to a PC and use PC resident software to accomplish the editing task. The software response of the method of the present invention is designed to be very easy to operate.

For example, assuming that the user wishes to transfer data from his/her cell phone to a PC, the user simply plugs the apparatus of the present invention into his/her cell phone using the appropriate connector. The IDTP senses power from the cell phone and automatically turns on, doing an internal check to see that all functions are operating properly and checks to see that the cell phone is compatible by checking an internal device code. Once the internal check is complete the self contained software initiates a loop that waits for the user to enter a command via one of a plurality of buttons. For example, the user may depress the Backup button, signaling the self contained software to commence fetching data from the memory of the cell phone. The data are copied from the cell phone memory to the memory of the apparatus where they remain until the user takes some further action.

Once the data from the cell phone are stored in the memory of the apparatus of the present invention, the user disconnects the cell phone and connects the apparatus to a PC, for example by way of a USB connection. Since the IDTP senses that power from the cell phone has been lost, the apparatus of the present invention shuts down. However, upon connecting to the PC, the IDTP again senses power via the USB interface and accomplishes the power on steps as stated above except that no device compatibility code is checked since the apparatus is now connected to a PC.

Since the data from the cell phone were stored in the non-volatile memory of the apparatus of the present invention, they are now ready to be transferred to the PC. The user simply launches an application program on the PC and follows the procedures for operation of the program to transfer the data from the memory of the apparatus to the memory of the PC. The application program contains the necessary functionality to edit data. By way of example, a user can modify existing data, add new data or delete existing data.

Once done the user reverses the process, updating the memory of the apparatus from the PC, disconnecting from the PC, reconnecting to the cell phone and then updating the cell phone memory. In this way the user may transfer data contents from a cell phone to a PC using a single apparatus and alternately connecting the apparatus to the cell phone or the PC.

The present invention also provides a system for users to update or upgrade the resident software in their data transfer apparatus. For example, suppose a user responded to a cell phone manufacturer's sales drive and, as a result, now has a newer version. With the system of the present invention, in concert with the method, the user can attach to a network, download the updated or upgraded code, and not have to purchase a new data transfer apparatus. As with the process described briefly above, internal code checks are made to ensure that the present cell phone is compatible with the selected upgrade.

Other improvements are made in the present invention. One such improvement is the use of interchangeable cell phone connectors allowing a user to take advantage of the capabilities of the apparatus over a wide range of target cell phones simply by changing the cell phone interface connector. This connector, referred to as a Manufacturer's Attribute Adapter (MAA) has a common connection characteristic to the processor side of the IDTP and a custom connection characteristic to a plurality of target cell phones.

As can be seen, the method, apparatus and system of the present invention offer a distinct economic and efficiency benefit to the user. This and other features and advantages of the present invention are discussed in detail below in conjunction with the drawings and figures attached.

### BRIEF DESCRIPTION OF THE DRAWINGS

FIG. 1: is a block diagram of the preferred embodiment of the apparatus of the present invention showing all possible interfaces.

FIG. 2: is a block diagram of a first embodiment of the apparatus of the present invention configured to interface with a cell phone using a UART protocol.

FIG. 3: is a block diagram of a first embodiment of the apparatus of the present invention configured to interface with a cell phone using a USB protocol.

FIG. 4: is a block diagram of the present invention configured to accomplish an apparatus-to-apparatus data transfer.

FIG. 5: is a top level flow chart of the method implemented on the apparatus of the present invention.

FIG. 6: is a detailed flow chart of the CPU Internal Test which is part of the method implemented on the apparatus of the present invention.

FIGS. 7A-C: is a detailed flow chart of the Cell Phone Interface Process which is part of the method implemented on the apparatus of the present invention.

FIGS. 8A-J: is a detailed flow chart of the of an application program which is part of the method the present invention that may be executed on a personal computer.

FIG. 9: is a screen shot of the Welcome screen of the application program of the present invention.

FIG. 10A-B: are screen shots of the Edit screens of the application program of the present invention.

FIG. 11A: is a screen shot of the Check Compatible Phones screen of the application program of the present invention.

FIG. 11B: is a screen shot of the Upgrade Screen of the application program of the present invention.

FIG. 12A-B: are screen shots of the Update screens of the application program of the present invention.

FIG. 13: is a screen shot of the Transfer Phonebook screen of the application program of the present invention.

FIG. 14: is a screen shot of the Help & Support screen of the application program of the present invention.

FIG. 15: is a detailed flow chart of the IDTP apparatus to IDTP apparatus data transfer process which is part of the method implemented by the present invention.

FIG. 16A: shows a preferred embodiment of the IDTP apparatus to IDTP apparatus transfer configuration that may be implemented by the present invention using a combination power cord and data cable.

FIG. 16B: shows a second preferred embodiment of the IDTP apparatus to IDTP apparatus transfer configuration that may be implemented by the present invention using separate power cord and data cable.

FIG. 16C: shows an alternate embodiment of the IDTP apparatus to IDTP apparatus transfer configuration using a cord mounted switch that may be implemented by the present invention.

FIG. 16D: shows an embodiment of the IDTP apparatus to IDTP apparatus transfer configuration using cell phones that may be implemented by the present invention.

FIG. 17: shows an alternate embodiment of the apparatus of the present invention using interchangeable Manufacturer's Attribute Adapters.

### DETAILED DESCRIPTION OF PREFERRED EMBODIMENTS

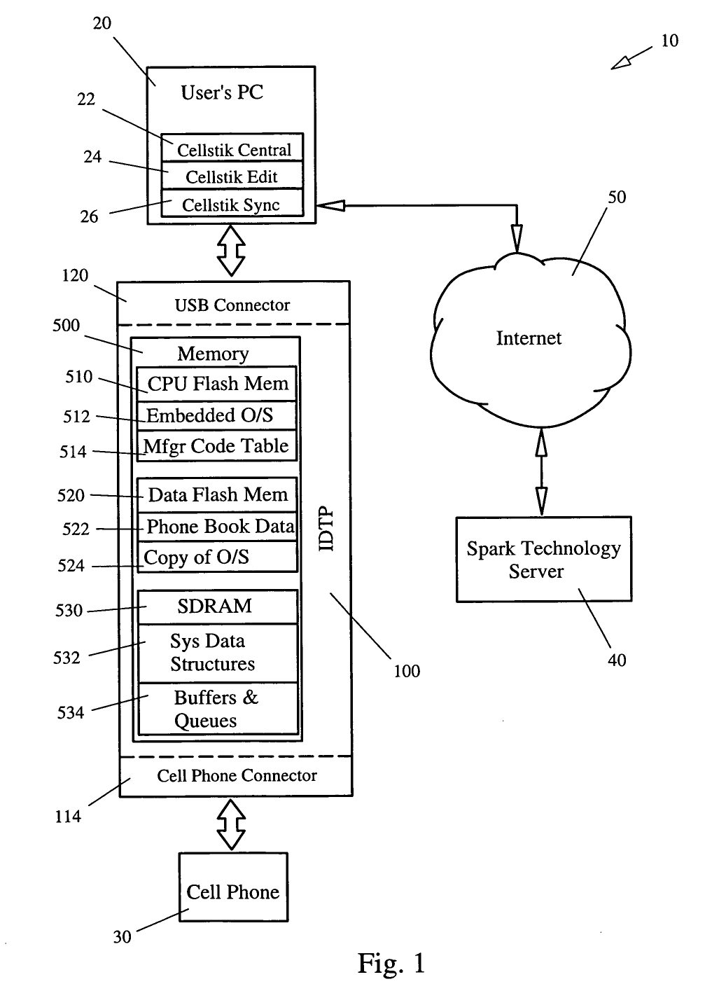

As described briefly above, the improved method, apparatus and system of the present invention provide a user with the ability to transfer the data contents of the memory of a cell phone to another cell phone or to any of a plurality of other target digital devices. FIG. 1 is a high level block diagram 10 of a preferred embodiment of the apparatus of the present invention showing all possible interfaces. Note that while the figure shows the apparatus of the present invention connected to both a cell phone and a PC, in operation this does not occur. The apparatus of the present invention may be connected either to a cell phone or to a PC depending upon the operation to be completed. The figure is drawn as it is to provide the reader with an overview of the types of connections possible.

An IDTP 100 contains a CPU (not shown) and Memory 500. Also present, but not shown for clarity are User Controls & Indicators, I/O Circuits, Data Buses and other details needed for operation of a digital device. Where necessary to the disclosure of the present invention, these items will be discussed in detail below. Note that Memory 500 is actually comprised of three separate memories: CPU Flash Memory 510 containing an embedded O/S (Operating System) 512 and Manufacturer's Code Tables 514; Data Flash Memory 520 containing Phone Book Data 522 and a Copy of the O/S 524; and SDRAM (Synchronous Dynamic Random Access Memory) 530 containing System Data Structures 532 and Buffers & Queues 534. Also note that while Memory 500 is shown as a single block, parts of the memory are distributed between the CPU and other integrated circuit devices.

USB Connector 120 interfaces with the IDTP 100 to allow communication with external devices such as the User's PC 20. Cell Phone Connector 114 is used to allow a user to connect his/her cell phone, for example Cell Phone 30, to the ITDP 100. As will be discussed below in detail, there are many more devices and features of IDTP 100 that impinge upon the apparatus and method of the present invention, but are not addressed here for clarity.

One of the benefits of the present invention is that it may be connected to an external digital device, such as User's PC 20. Because User's PC 20 has it's own processing and data storage capability it can be used to enable certain software applications programs that enhance the method of the present invention. As shown, software applications CellStik Central 22, CellStik Edit 24, and CellStik Sync 26 are stored on User's PC 20. As will be discussed in detail below each of these applications programs provide a user with novel functions in conjunction with the apparatus of the present invention. However, as a brief introduction, CellStik Central application 22 is used in concert with the Internet 50 and Spark Technology Server 40 to allow a user to update their cell phone via a network connection. CellStik Edit application 24 is used to allow a user to edit data downloaded to the User's PC 20 and CellStik Sync application 26 is used to synchronize data between a user's cell phone and external PIM (Personal Information Management) software such as Outlook™ from MicroSoft, Redmond, Wash. or Lotus Notes™ from IBM, Armonk, N.Y.

While CellStik Central application 22 and CellStik Edit 24 are discussed in detail below, a detailed discussion of CellStik Sync application 26 is not provided since the functions associated with this application are performed in the customary way and do not impinge on the method of the present invention. However, lack of a detailed discussion of this function should not be read as a limitation on the scope of the invention. Further, it will be understood that although the external digital device shown is a PC, it would be possible to use any compatible digital device having storage and processing capability without departing from the spirit of the invention, thus the use of a PC should not be read as a limitation on the scope of the invention. By way of example, the User's PC could just as well be a PDA (Personal Digital Assistant) as long as it was capable of interfacing to and running the software applications programs.

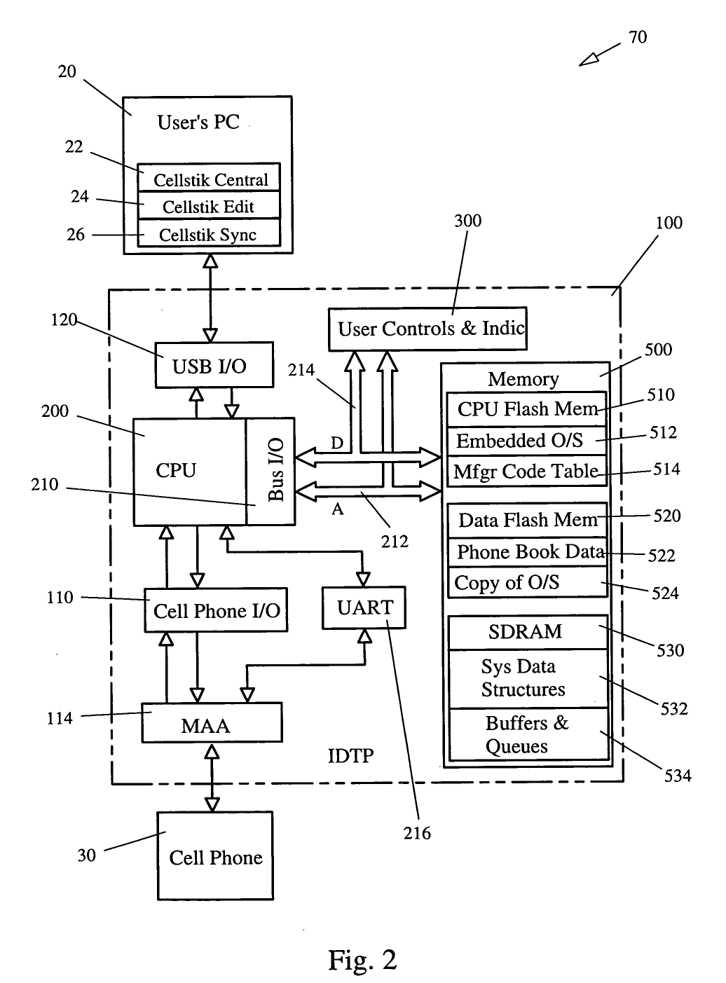

FIG. 2 provides a detailed block diagram 70 of a first preferred embodiment of the apparatus of the present invention. Note that while the figure shows the apparatus of the present invention connected to both a cell phone and a PC, in operation this does not occur as explained previously in conjunction with FIG. 1. The heart of the apparatus 100 contains a CPU 200 which communicates with a Memory 500 and User Controls & Indicators 300 via Bus I/O 210 and data and address busses A 212 and D 214. This communication is done in the conventional manner thus is not discussed in detail here since it does not impinge directly on the operation of the present invention. In this preferred embodiment of the apparatus of the present invention the CPU 200 is a AT91SAM7S64A1 from Atmel Corporation, San Jose, Calif.

Memory 500 is comprised of three separate section, or chunks, of memory. Two of these chunks, SDRAM 530 and CPU Flash Memory 510, are built in to CPU 200. CPU Flash Memory 510 contains an Embedded O/S (Operating System) 512 and a Manufacturers Code Table 514. The function of the O/S 512 is to provide the processing capability for the apparatus of the present invention. In this preferred embodiment the O/S 512 is a UC/OS-II™ from Micrium, Inc., Weston, Fla. However, it will be understood that any O/S could be used without departing form the spirit of the invention, thus the use of the UC/OS-II™ O/S is exemplary only.

The SDRAM 530 contains System Data Structures 532 and Buffers & Queues 534. The System Data Structures 532 include the necessary data elements for use by the method of the present invention. To aid in clarity, only those data structures that are directly involved with the method of the present invention will be discussed in detail. This discussion occurs below in conjunction with the detailed presentation of the process and flow charts. The same is true for Buffers & Queues 534 which form the requisite temporary data handling locations. Both the System Data Structures 532 and Buffers & Queues 534 perform in a conventional manner.

Data Flash Memory 520 is comprised of Phone Book Data 522 and a Copy of O/S 524. The function of the Phone Book Data 522 is to hold data coming from or going to the user's Cell Phone 30 or to or from User's PC 20. These data are written to or read from Phone Book Data 522 under the control of the method of the present invention as discussed in detail below. The Copy of O/S 524 is needed when the existing O/S 512 is being upgraded. A new O/S 524 is written prior to the beginning of the upgrade process. Once the upgrade is completed the system is reinitialized and once operating properly the Copy of O/S 524 is no longer used. In this preferred embodiment of the apparatus of the present invention the Data Flash Memory 520 is a AT45DB011B from Atmel Corporation, San Jose, Calif.

User Controls & Indicators 300 are comprised of a set of two switches and three LEDs (Light Emitting Diodes). Each of these is discussed below in conjunction with the discussion of the method of the present invention, however, briefly the two buttons are Update and Save. Each is shaped like an arrow to indicate to the user in which direction the data will flow when the button is pressed. The Update button passes data from the apparatus of the present invention to the user's cell phone while the Save button passes data from the user's cell phone to the apparatus.

The three LEDs that are part of User Controls & Indicators 300 are a centrally mounted red LED and two green data direction LEDs mounted towards the edges of the body of the apparatus. The function of the red LED, which is of a hexagonal shape, is to indicate an error to the user. The hexagonal shape is used since it represents the notion of a “stop” sign. The two green LEDs are shaped like arrows; one for each direction of data flow. Each of these green LEDs is physically associated with one of the buttons. Thus when the user presses the Update button, the green LED pointing from the apparatus to the user's cell phone will light, and vice versa for the Save button.

Returning to CPU 200, note that there exist two ports operating to interface the apparatus of the present invention to the outside world. The first of these is the Cell Phone I/O port 110. Cell Phone I/O 110 works in concert with UART 216 to pass signals from the CPU 200 to the MAA (Manufacturer's Attribute Adapter) 114. Note that UART 216 and Cell Phone I/O are actually a part of the CPU 200 but are shown as a separate block for logical clarity. MAA 114 connects the apparatus of the present invention to the user's Cell Phone 30.

One novel feature of the present invention is the use of MAA 114. To allow the user to change cell phone manufactures and continue to use the apparatus of the present invention, a plurality of MAAs are available. When the user changes phone manufacturers the user simply needs to change the MAA. The apparatus of the present invention advantageously contains a table of manufactures codes that allows the method of the invention to determine if the newly connected cell phone is compatible. It should be noted that while the preferred embodiments of the present invention make use of the MAA, lack of such an adaptive device should not be read as a limitation on the scope of the invention since the method of the present invention works just as well without it.

The second output port of the CPU 200 is USB I/O 120. This interface is used to connect the apparatus of the present invention to an external digital device, such as User's PC 20. This interface works in the customary manner and in this preferred embodiment the USB I/O 120 is an integral part of CPU 200. It is shown separately for clarity. The USB I/O 120 passes data from the application programs CellStik Central 22, CellStik Edit 24 and CellStik Sync 26 in the manner discussed briefly above. A more detailed discussion of the use of this port appears in conjunction with the detailed method description below.

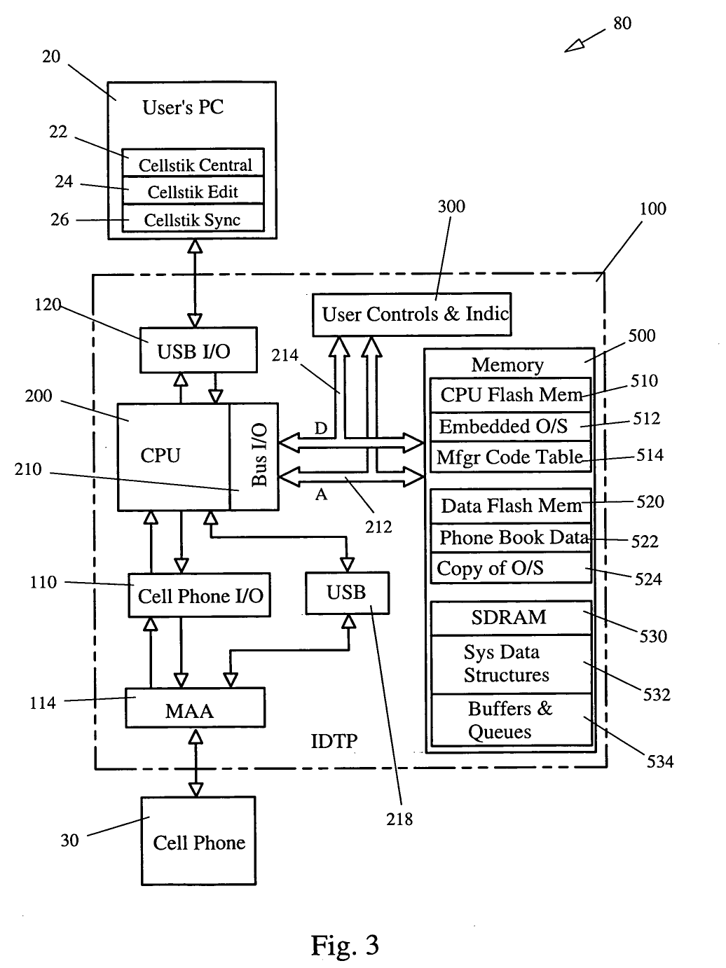

FIG. 3 provides a detailed block diagram 80 of a second preferred embodiment of the apparatus of the present invention. Note that while the figure shows the apparatus of the present invention connected to both a cell phone and a PC, in operation this does not occur as explained previously in conjunction with FIG. 1. As can be seen, each of the labeled items has an exact one-to-one correspondence with the similarly labeled item in FIG. 2 with the sole exception of USB 218. The USB 218 interface chip is a SL811HST-AC from Cypress Semiconductor Corporation, San Jose, Calif. in this second preferred embodiment. USB 218 is used to interface with cell phones that require a USB protocol rather than the UART protocol of the first preferred embodiment. Each of the remaining items in FIG. 3 perform exactly as their counterparts in FIG. 2 so are not discussed further here.

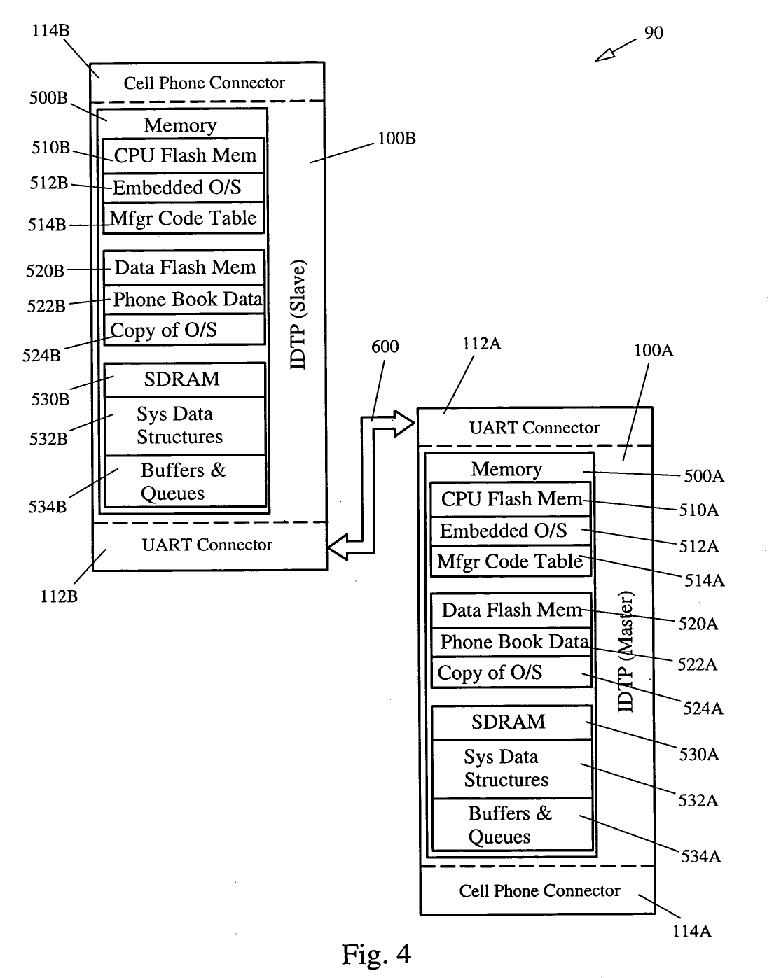

Another novel and unique feature of the present invention is the ability to transfer data between two apparatuses of the present invention. FIG. 4 provides a block diagram 90 of how this is accomplished. Two IDTPs 100A and 100B are connected by a custom cable 600 via UART Connectors 112A and 112B. The cable 600 is of the Rx/Tx type and effectively provides the required connection that allows the use of the CPU's built in UART, for example UART 216 in FIG. 2. As can be seen, no cell phone is attached to either cell phone connector 114A or 114B.

Each of the IDTPs 100A and 100B contain a memory, for example Memory 500A and 500B. These memories each contain CPU Flash Memory (510A and 510B), Data Flash Memory (520A and 520B) and SDRAM (530A and 530B). As was described above, the CPU flash memory contains Embedded O/S (512A and 512B) and a Manufacturer's Code Table (514A and 514B). Similarly data flash memory contains Phone Book Data (522A and 522B), and a Copy of O/S (524A and 524B). Also, SDRAM contains System Data & Structures (532A and 532B) and Buffers & Queues (534A and 534B). In operation the various program instructions contained in IDTP 10A, for example, allow a user to transfer data to or from IDTP 100B. Which of the IDTPs is master and which is slave depends on which button is activated. If a button on IDTP 100A is depressed, it becomes the master for that session. The converse is true of the user presses a button on IDTP 100B.

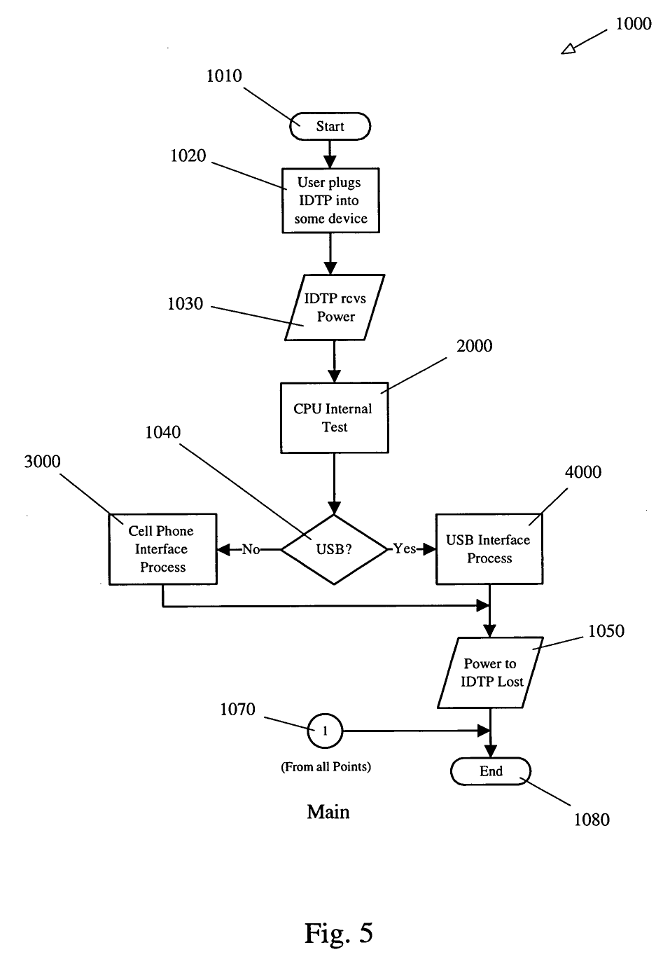

FIGS. 5 through 8 present a detailed discussion of the method of the present invention. In the discussion the like numbered symbols are assumed to be the same logical point. For example, where a circle with the number 1 inside appears, all points having the same symbol with the same number are assumed to be the same logical point regardless of which drawing sheet they appear on. For the discussion it is assumed that the apparatus is in proper operating condition and the user is familiar with the operational characteristics of the invention. It is also assumed that where indicated the external digital device connected to the IDTP is a PC and that the cell phone connected is compatible. Further, where the method of the present invention operates in conformance with conventional digital devices a detailed discussion of the method will be left out to aid in clarity. Thus only those operations that directly impinge on the method of the present invention are discussed in detail.

Beginning with FIG. 5, a top level flow chart 1000 of the method of the present invention is shown. The method starts at Start step 1010. At User Plugs IDTP into some device step 1020 the user inserts one of the two connectors of the apparatus of the present invention into a device. At this point in time the method does not know what the external digital device is. However, whatever the device, power is supplied to the IDTP at IDTP Receives Power 1030. At this point in time the process passes to the CPU Internal Test 2000.

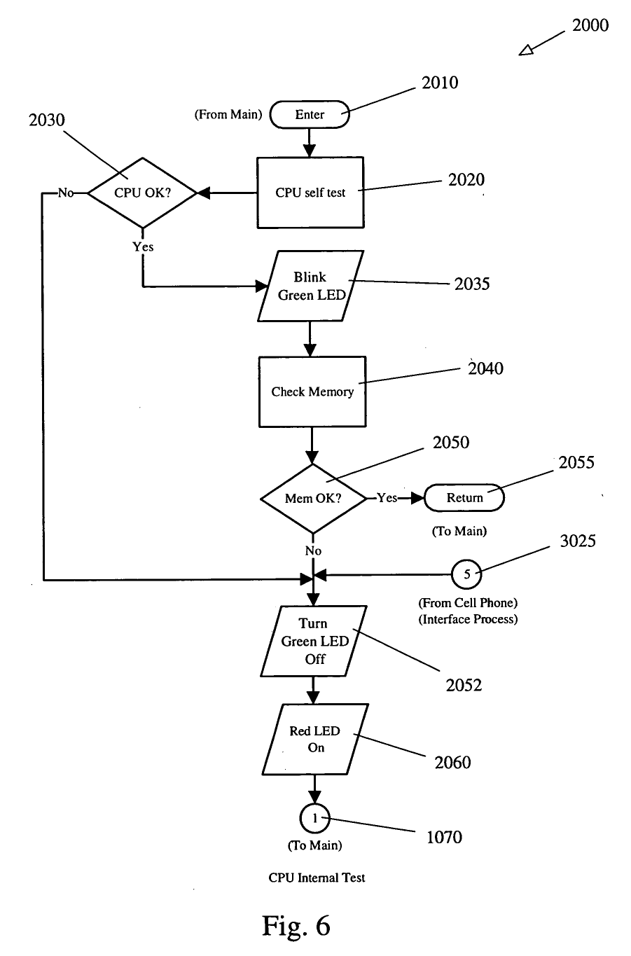

FIG. 6 is a detailed flow chart 2000 of the CPU Internal Test portion of the method of the present invention. The process is entered from the Main flow 1000 at Enter 2010. At CPU Self Test 2020 the internal test of the CPU is completed. Note that the exact details of this internal check depend on the specific device. However, each manufacturer has their own specific set of power on tests that determine whether or not the CPU is alive and operational. The precise details of this test to not impinge on the method of the present invention so are not discussed in detail. This lack of a detailed discussion should not be read as a limitation on the scope of the invention.

At CPU OK decision 2030 the process determines if the self test was successful. If the CPU is not capable of performing, the No branch is followed to Turn Green LED Off step 2052 where the green LEDs are turned off. At Red LED On step 2060 the red LED is turned on to indicate to the user that the IDTP has failed a power up and that corrective action must be taken before proceeding. From here the process returns to Main via off page connector 1 1070 where the process stops at End step 1080.

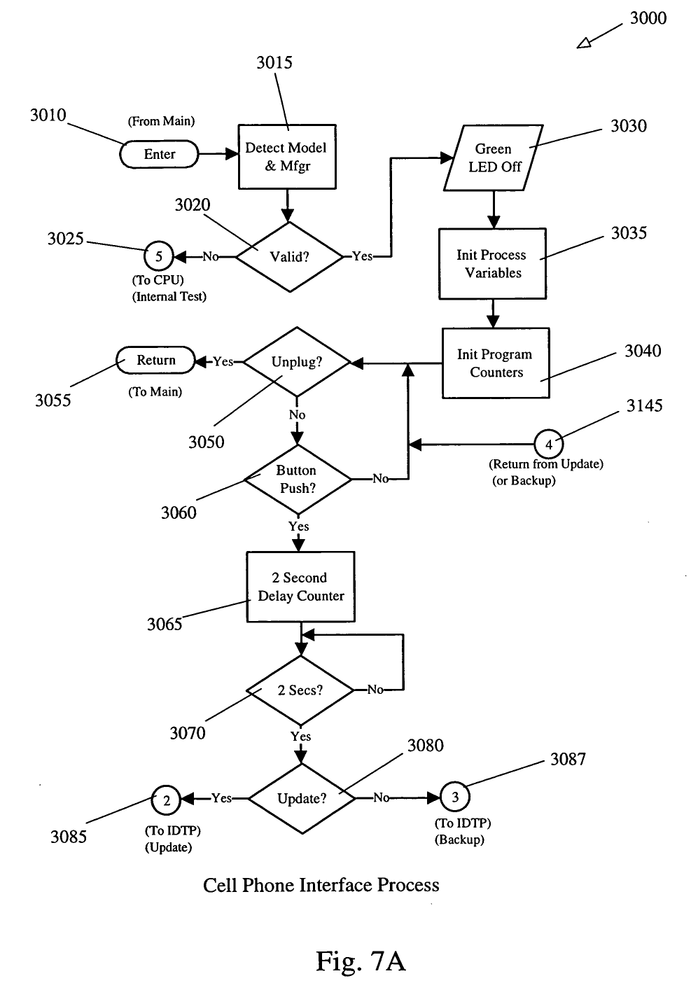

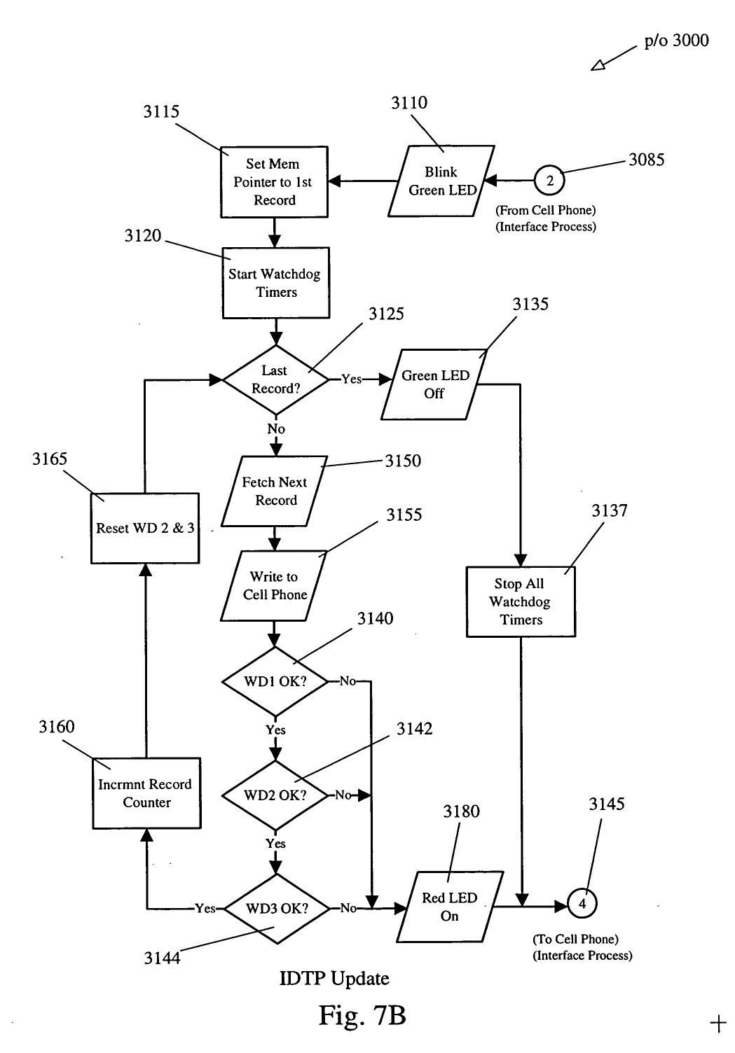

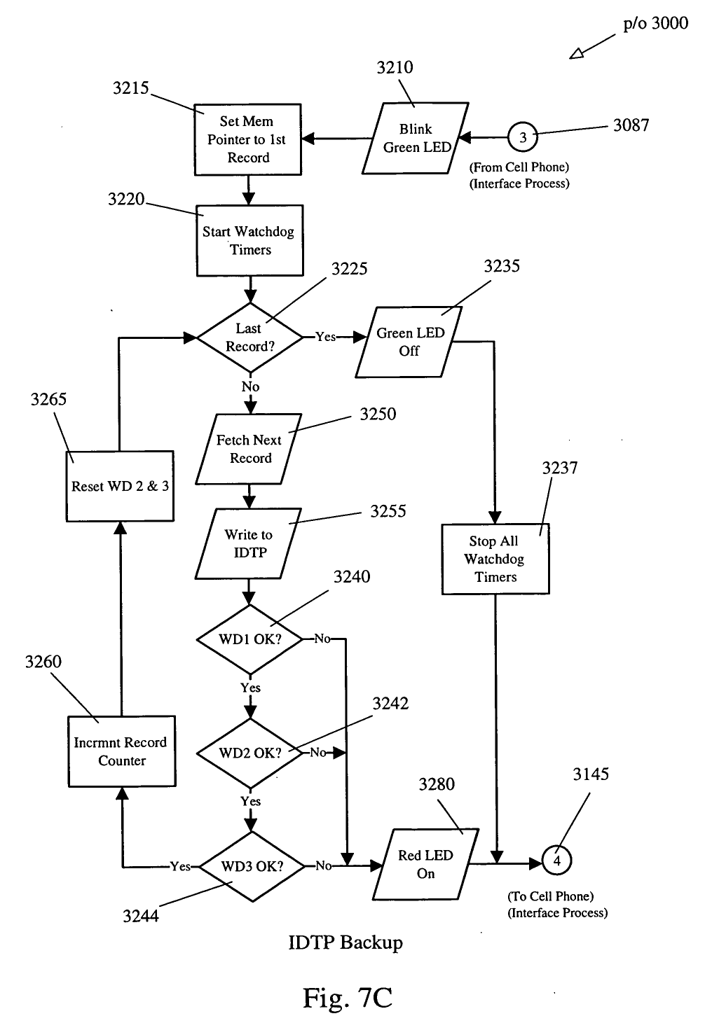

If the CPU test was successful the Yes path is taken out of CPU OK decision 2030 where the process enters the Blink Green LED step 2035. At this time the green LEDs are set to the standard blink mode of 5. seconds on, 0.5 seconds off to indicate to the user, that the CPU is operational. It will be recognized that other blinking rates could be used without departing form the spirit of the invention, thus the blink rate used is exemplary only. the precise details of this test to not impinge on the method of the present invention so are not discussed in detail. This lack of a detailed discussion should not be read as a limitation on the scope of the invention. The process advances to the Memory OK decision 2050. If the test was successful the process moves to Main via Return step 2055. If the test failed, the No path is followed out of Memory. OK decision 2050 to Red LED On step 2060 where he red LED is turned on to indicate to the user that the IDTP has failed upon power up and that corrective action must be taken before proceeding. From here the process returns to Main via off page connector 1 1070 where the process stops at End step 1080. Off page connector 5 3025 is a reentry path from another part of the method of the present invention and will be discussed in detail below in conjunction with FIG. 7A.

Returning to FIG. 5, and assuming that the CPU Internal Test 2000 was successful, the process enters the USB decision 1040. Here the method of the present invention determines what type of device the IDTP has been plugged into. Recall from the discussion of the apparatus of the present invention from above that there are two connectors that may be used to transfer data to and from the IDTP. One of these connectors attaches the IDTP to a cell phone and the other to an external digital device such as a PC. At USB decision 1040 the method of the present invention determines which type of device is connected by determining which connector is in use. If the USB connector (120 in FIG. 1) is in use, the connected device is a PC. If the cell phone connector (114 in FIG. 1) is in use, then the IDTP is connected to a cell phone. In either case the presence of a connection is detected using a voltage detector in the customary way. Since the detection of the connection is accomplished using conventional means the actual circuit is not discussed in detail to aid in clarity, however, absence of such a discussion should not be read as a limitation on the scope of the invention.

If the IDTP has been connected to a cell phone, the No path is followed out of USB decision 1040 where the process enters the Cell Phone Interface Process 3000. If the IDTP has been connected to a PC, the Yes path is followed out of USB decision 1040 where the process enters the USB Interface Process 4000. Each of these processes is discussed in detail below in conjunction with FIGS. 7A through 7C. For now it is enough to know that the only way out of these processes is to return to Main flow 1000. Upon returning from either process, the process enters the Power to IDTP Lost step 1050. Once power has been lost the process enters the End step 1080 where the method of the present invention stops. Off page connector 1 1070 is the return path from several process points on other drawing sheets.

Turning now to FIG. 7A the Cell Phone Interface Process 3000 is shown. For the discussion of this portion of the method of the present invention it is assumed that the user has attached the IDTP to his/her cell phone and that the power up and internal check sequences have been successful. The process is entered via the Enter step 3010. At Detect Model & Manufacturer step 3015 the method of the present invention reads the code in the attached cell phone and compares it to table of codes contained in memory (514 in FIG. 1). Supposing that the code in not valid, the No path is followed out of Valid decision 3020. Process control transfers to the CPU Internal Test flow 2000 via off page connector 5 3025 where the red LED is turned on to alert the user that a problem exists.

Supposing now that the code that has been read is valid, the Yes path is followed out of Valid decision 3020. At Green LED Off step 3030 the green LEDs turned off informing the user that the IDTP has been connected successfully, that the cell phone model is valid and that data may now be sent to or retrieved from the cell phone. At Init Process Variables step 3035 the various temporary values that are used by the method of the present invention are initialized. Exactly what these variables are is unimportant as they do not effect the method of the invention and they operate in the same manner as other variables in contemporary digital devices, however, by way of example such variables include LED State, Model Number Detected and Cell Phone Serial Number to name a few. These variables are contained in System Data Structures (532 in FIG. 1) in memory.

In a like manner the program counters are initialized at Init Program Counters step 3040. Several counters are used and each operates according to conventional principles. Examples include the Record Counter, Loop timer, Transfer Watchdog Timers and Button Delay Timer. It will be recognized that the absence of an exhaustive list of program variables, timers and counters should not be read as a limitation on the scope of the invention. Once initialization of the program variables, timers and counters is complete the process advances to the Unplug decision 3050.

At Unplug decision 3050 the method of the present invention determines if the user has disconnected the IDTP from its source of power. This step is required because until power is removed the method of the present invention remains active, if only in an idle loop. If the IDTP has been disconnected the process follows the Yes path, returning to the Main flow 1000 via Return step 3055. the process flow then enters the Power to IDTP Lost step 1050 and the process terminates as described above.

If the IDTP has not been disconnected the No path is followed out of Unplug decision 3050 entering the Button Push decision 3060. If no button is being depressed the No path is followed leading back to the Unplug decision 3050. The Unplug decision 3050 and the Button Push decision 3060 form an idle loop. The method of the present invention will continue to process these two steps until a button is depressed. When that occurs the Yes path is followed out of Button Push decision 3060 causing process control to pass to the 2 Second Delay Counter 3065. 2 Second Delay Counter 3065 is a switch closure de-bounce mechanism ensuring that the signal from the IDTP control truly represents a user button closure and not an accidental press such as might occur while connecting or disconnecting the IDTP to some other device. The 2 Seconds decision 3070 simply tests to see that the delay time has passed. Once the timer has run process flow passes to Update decision 3080.

At Update decision 3080 the method of the present invention determines which button the user has depressed. Recall from above that there are two buttons on the IDTP: one for update and one for backup. If the user has depressed the update button the Yes path is followed out of the Update decision 3080, entering the IDTP Update flow shown in FIG. 7B via off page connector 2 3085. If the user has depressed the backup button, the No path is followed to the IDTP Backup flow shown in FIG. 7C via off page connector 3 3087. Off page connector 4 3145 is the return path from either the IDTP Update or IDTP Backup flow and is discussed in detail just below.

FIG. 7B presents a flow chart of the IDTP Update process which is part of the Cell Phone Interface Process 3000. Note that some cell phone architectures prohibit data transfer to cell phone memory if there is already data present. For these models the cell phone memory must first be cleared before any updated data may be transferred. Other cell phone models permit updated data to be transferred in without such a clearing step. The method of the present invention may be used with either type of cell phone architecture. For purposes of the following discussion it is assumed that the particular cell phone being updated is of the type that allows data to be transferred to a populated cell phone memory. For those models that do require the cell phone memory to be cleared the method of the present invention first performs the memory clearing step, then commences the transfer as described just below. The memory clearing step is accomplished in the conventional manner and is thus not discussed in detail to aid in clarity. However, the lack of such a detailed discussion should not be read as a limitation on the scope of the invention.

Entry into the IDTP Update process is made via off page connector 2 3085. At Blink Green LED step 3110 the method of the present invention causes the green LED that has been solidly-off to begin blinking at a rate of 0.5 second on and 0.5 second off. The LED is made to blink to inform the user that the button press has been accepted and that the process is moving forward. At Set Memory Pointer to 1^{st} Record step 3115 the IDTP memory location that contains the address of the first data record is set. At Start Watchdog Timers step 3120 the three watchdog timers are set to their initial values. As explained in detail below, these watchdog timers are used to monitor the progress of the transfer operation. At this point in time the IDTP is ready to begin transferring data from the IDTP memory to the cell phone memory.

A loop is now executed by the method of the present invention that fetches a data record from the IDTP memory (522 of FIG. 1), transfers it to cell phone memory, then fetches the next record. This process repeats until the last record has been transferred. The loop begins at Last Record decision 3125. This step is required to inform the method that all data have been transferred and it is time to exit the loop. Supposing that it is not the last record the No path is followed to the Fetch Next Record step 3150 where the next record in memory is retrieved.

A series of decisions is now executed that determine whether or not the process is performing normally. At Watchdog Timer 1 (WD1 OK decision 3140 the first timer is checked to see if it has expired. If not, the Yes path is followed causing process control to pass to the WD2 OK decision 3142. WD1 is used to determine if the overall transfer process has been completed normally. The time limit for WD1 can vary from four to thirty minutes depending upon the exact manufacturer and model of the target cell phone and the number of records to be tansferred. The time for WD1 is loaded as part of the information gathered during the validation check sequence described above.

At WD2 OK decision 3142 the second timer is checked to see if it has expired. If not, the Yes path is followed causing process control to pass to the WD3 Ok decision 3144. WD2 is used to monitor if the transfer loop process consisting of Last Record decision 3125, Fetch Next Record step 3150, Write to Cell Phone step 3155, WD1 through WD3 decisions 3140 through 3144, Increment Record Counter step 3160 and Reset WD2 & 3 step 3165. The time limit for WD2 is two seconds in a preferred embodiment of the present invention, however, it will be noted that different times could be used for timer WD2 without departing from the spirit of the invention. The time for WD2 is fixed and is loaded as part of the Initialize Process Variables step 3035 described above.

At WD3 OK decision 3144 the third timer is checked to see if it has expired. If not, the Yes path is followed causing process control to pass to the Increment Record Counter step 3160. WD3 is used to monitor if the Write to Cell Phone step 3155 to ensure that the current record has been properly transferred to the target cell phone. The time limit for WD3 is two hundred milli-seconds in a preferred embodiment of the present invention, however, it will be noted that different times could be used for timer WD3 without departing from the spirit of the invention. The time for WD3 is fixed and is loaded as part of the Initialize Process Variables step 3035 described above.

Supposing that the process is running normally process control enters the Increment Record Counter step 3160 where the next record in succession is pointed to. At Reset WD2 & 3 step 3165 the two short duration timers are reset in anticipation of executing the next record transfer. The process then again enters the Last Record decision 3125 where the loop begins again.

Once all records have been transferred the Yes path is followed out of Last Record decision 3125. The green LED that has been blinking during the transfer process is now turned off at Green LED Off step 3135. Next the Stop All WD Timers Step 3137 is executed to prevent the process from stopping due to expiration of one of the watchdog timers. Process control returns to the Unplug decision 3050 via off page connector 4 3145 where the process enters the idle loop waiting for the user's next command. But suppose now that the transfer did not succeed as would be the case if any one of the three watchdog timers described just above fails. In this instance the process passes to the Red LED On step 3180. Flow then passes back to Cell Phone Interface Process via off page connector 4 3145. Once the process has returned to the Cell Phone Interface Process the idle loop is entered at Unplug decision 3050 and the user must take some action.

FIG. 7C presents a flow chart of the IDTP Backup process which is part of the Cell Phone Interface Process 3000. Entry into the IDTP Backup process is made via off page connector 3 3087. At Blink Green LED step 3210 the method of the present invention causes the green LED that has been solidly off to begin blinking at a rate of 0.5 second on and 0.5 second off. The LED is made to blink to inform the user that the button press has been accepted and that the process is moving forward. At Set Memory Pointer to 1^{st} Record step 3215 the cell phone memory location that contains the address of the first data record is set. At Start Watchdog Timers step 3220 the three watchdog timers are set to their initial values. As explained in detail below, these watchdog timers are used to monitor the progress of the transfer operation. At this point in time the IDTP is ready to begin transferring data from the cell phone memory to the IDTP memory.

A loop is now executed by the method of the present invention that fetches a data record from the cell phone memory, transfers it to IDTP memory (522 of FIG. 1), then fetches the next record. This process repeats until the last record has been transferred. The loop begins at Last Record decision 3225. This step is required to inform the method that all data have been transferred and it is time to exit the loop. Supposing that it is not the last record the No path is followed to the Fetch Next Record step 3250 where the next record in cell phone memory is retrieved.

A series of decisions is now executed that determine whether or not the process is performing normally. At Watchdog Timer 1 (WD1) OK decision 3240 the first timer is checked to see if it has expired. If not, the Yes path is followed causing process control to pass to the WD2 OK decision 3242. WD1 is used to determine if the overall transfer process has been completed normally. The time limit for WD1 can vary from four to thirty minutes depending upon the exact manufacturer and model of the target cell phone. The time for WD1 is loaded as part of the information gathered during the validation check sequence described above.

At WD2 OK decision 3242 the second timer is checked to see if it has expired. If not, the Yes path is followed causing process control to pass to the WD3 Ok decision 3244. WD2 is used to monitor if the transfer loop process consisting of Last Record decision 3225, Fetch Next Record step 3250, Write to IDTP step 3255, WD1 through WD3 decisions 3240 through 3244, Increment Record Counter step 3260 and Reset WD2 & 3 step 3265. The time limit for WD2 is two seconds in a preferred embodiment of the present invention, however, it will be noted that different times could be used for timer WD2 without departing from the spirit of the invention. The time for WD2 is fixed and is loaded as part of the Initialize Process Variables step 3035 described above.

At WD3 OK decision 3244 the third timer is checked to see if it has expired. If not, the Yes path is followed causing process control to pass to the Increment Record Counter step 3260. WD3 is used to monitor if the Write to IDTP step 3255 to ensure that the current record has been properly transferred to the IDTP memory. The time limit for WD3 is two hundred milli-seconds in a preferred embodiment of the present invention, however, it will be noted that different times could be used for timer WD3 without departing from the spirit of the invention. The time for WD3 is fixed and is loaded as part of the Initialize Process Variables step 3035 described above.

Supposing that the process is running normally process control enters the Increment Record Counter step 3260 where the next record in succession is pointed to. At Reset WD2 & 3 step 3265 the two short duration timers are reset in anticipation of executing the next record transfer. The process then again enters the Last Record decision 3225 where the loop begins again.

Once all records have been transferred the Yes path is followed out of Last Record decision 3225. The green LED that has been blinking during the transfer process is now turned off at Green LED Off step 3235. Next the Stop All WD Timers Step 3237 is executed to prevent the process from stopping due to expiration of one of the watchdog timers. Process control returns to the Unplug decision 3050 via off page connector 4 3145 where the process enters the idle loop waiting for the user's next command. But suppose now that the transfer did not succeed as would be the case if any one of the three watchdog timers described just above fails. In this instance the process passes to the Red LED On step 3280. Flow then passes back to Cell Phone Interface Process via off page connector 4 3145. Once the process has returned to the Cell Phone Interface Process the idle loop is entered at Unplug decision 3050 and the user must take some action.

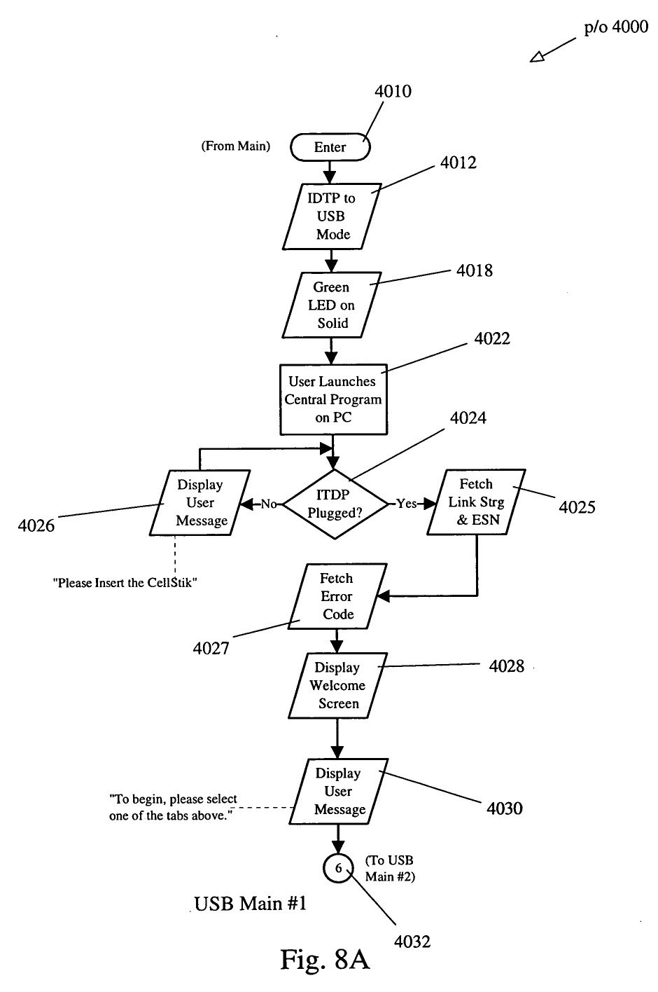

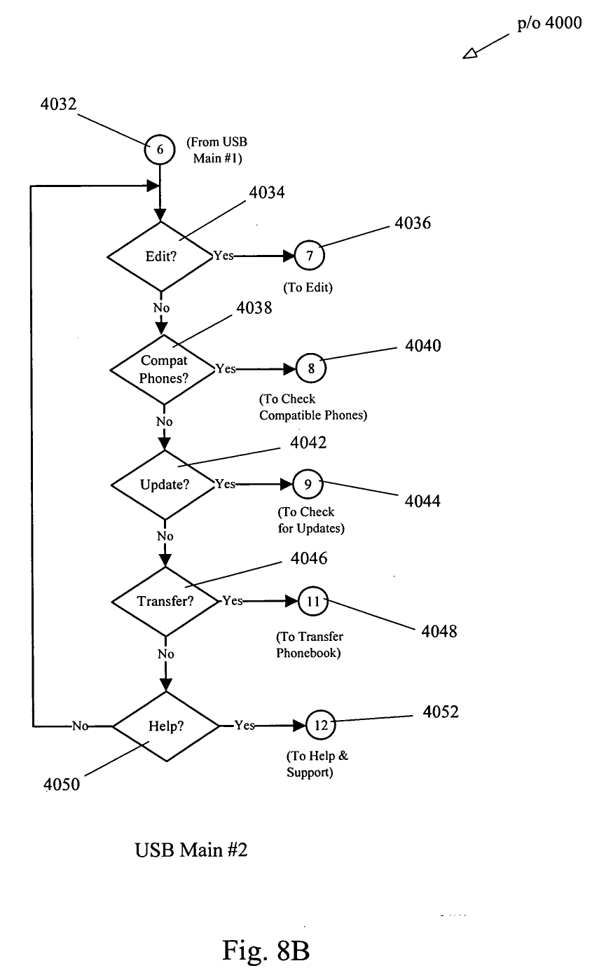

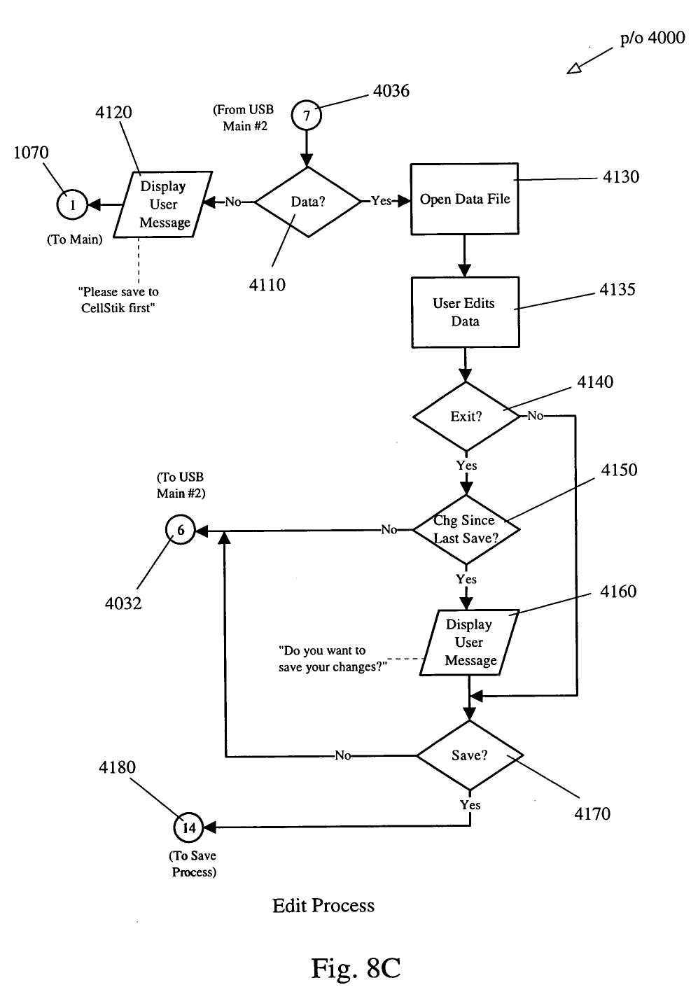

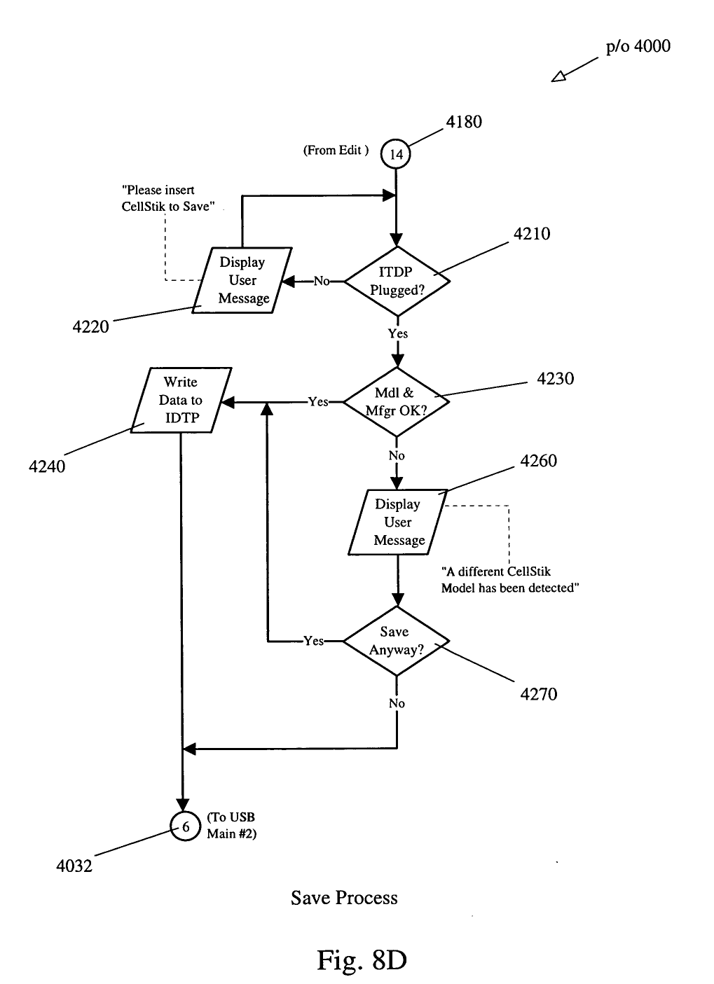

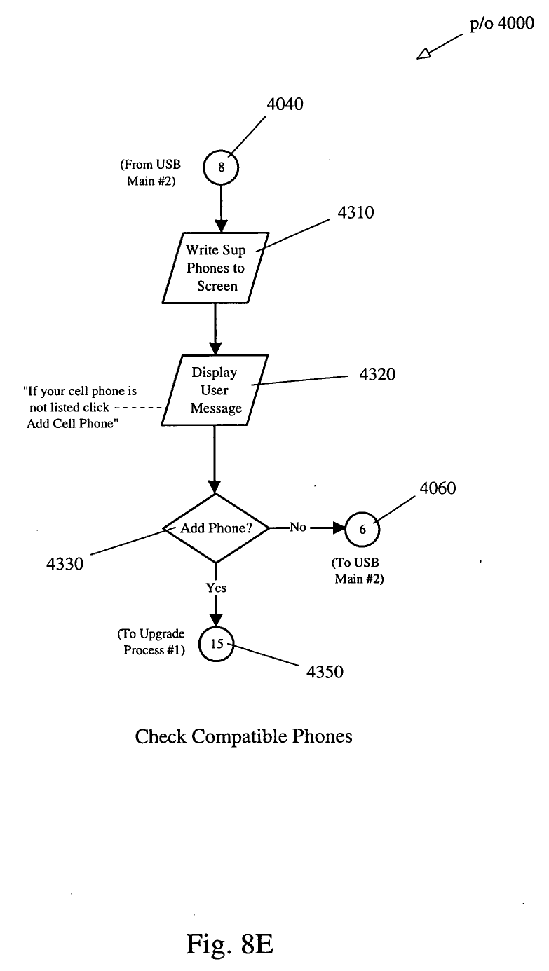

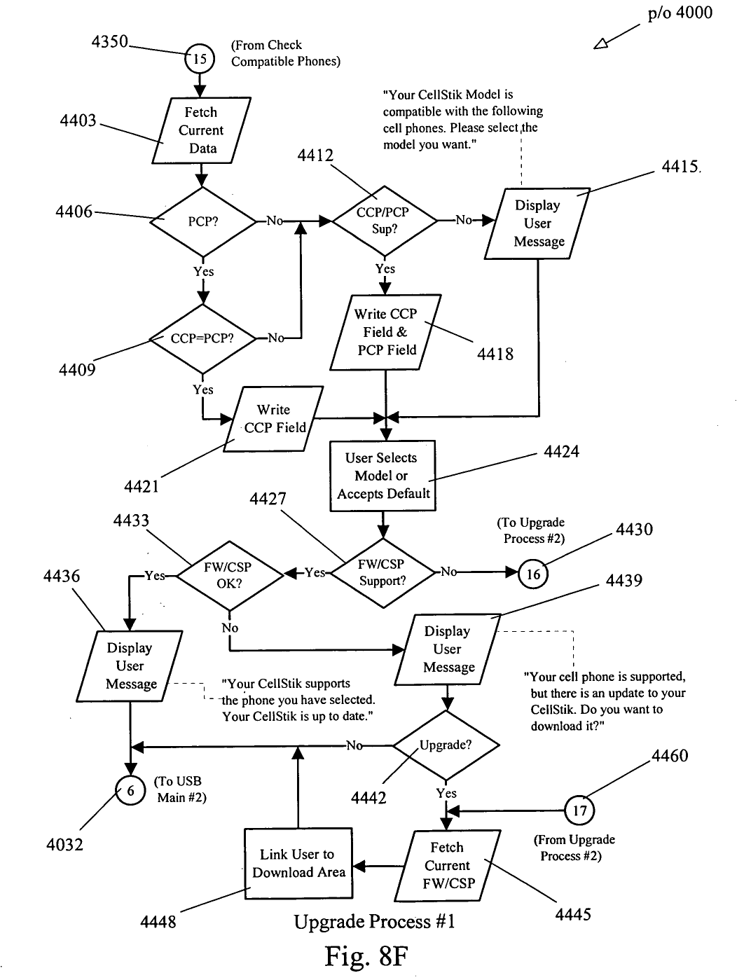

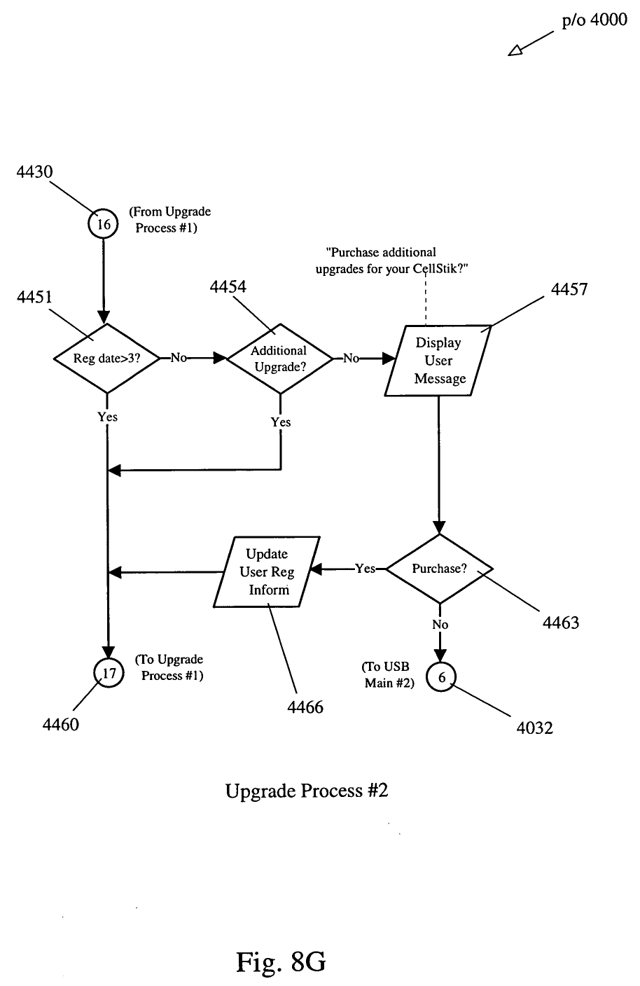

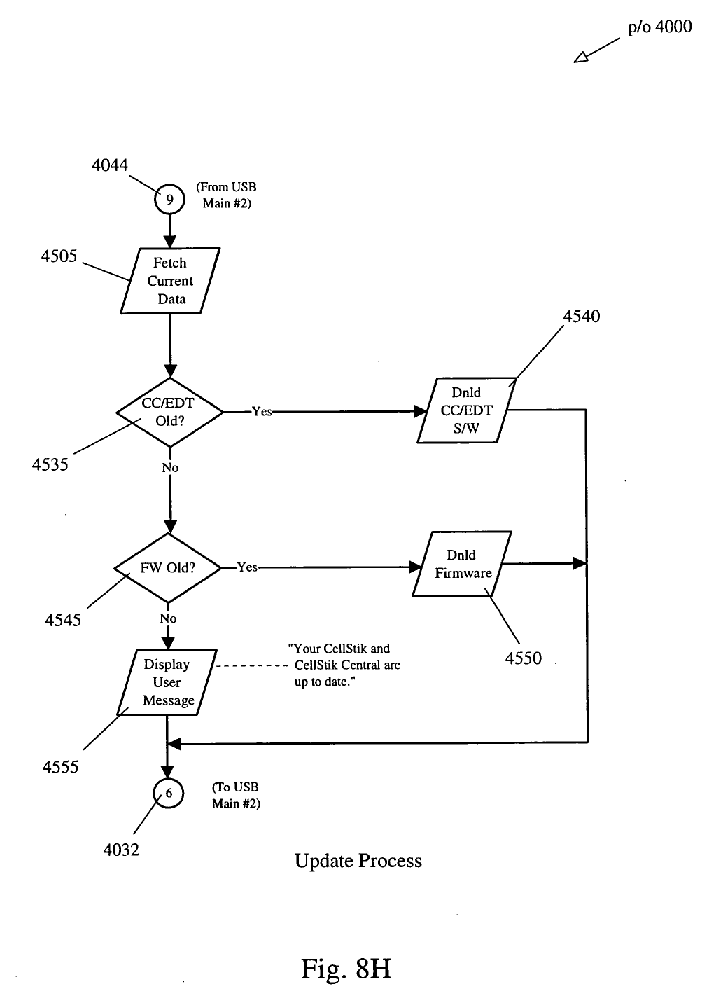

All of the operations associated with the previous discussions have centered on using the apparatus of the present invention to move data to and from one or more cell phones. Advantageously the method of the present invention includes a software application program that may be executed on an external digital device. For purposes of the following discussion, the external device is a PC, however, it will be understood that the application program discussed could be transported to any properly configured digital device, thus the use of a PC should not be read as a limitation on the scope of the invention. FIGS. 8A through 8J provide a detailed flow chart of the application program of the present invention. FIGS. 9 through 14 present screen shots of the application program in progress and are discussed in parallel with the flow chart. Thus, for example, where the discussion centers on the editing process, flow chart FIGS. 8C and 8D will be discussed concurrently with FIGS. 10A and 10B. Additionally, where a user is prompted or notified to take some action the message that is given is attached to the specified step by a dashed line. For example, at step 4020 in FIG. 8A the message “Unrecognized device attached” is posted on the screen so that the user knows he or she has a problem that needs to be resolved before continuing.

Looking first at FIG. 8A, the application program of the present invention begins at the Enter step 4010 when the user connects an IDTP to a PC via a USB port. When the IDTP detects power from the USB port the IDTP to USB Mode step 4012 is accomplished. It will be understood that the same power up sequence discussed in connection with FIG. 6 above occurs but is not discussed in detail here to aid in clarity. Once the USB protocol has been resolved the green LEDs change from a blinking state to a solid on state at Green LED On Solid step 4018, telling the user that the IDTP has been accepted. At Launch Central Program on PC step 4022 the process starts the application program. This is done in the conventional way by, for example, calling a .exe or .bat file from memory. Since this is accomplished in the customary manner there is no detailed discussion here. At IDTP Plugged decision 4024 the process confirms that an IDTP is present. If no IDTP is attached the No path is followed out of IDTP Plugged decision 4024 where the process posts a message to the user at Display User Message 4026 to prompt the user to attach the IDTP.

Once an IDTP is detected the process flow progresses to the Fetch Linkstring & ESN step 4025. A novel advantage of the present invention is that each IDTP carries its own unique ESN (Electronic Serial Number) as well as a data record, called the Linkstring, containing a number of important data fields including the PCP (Previous Cell Phone), CCP (Current Cell Phone), CSP (CellStik Service Pack), and revision levels of firmware and hardware. Each time the IDTP connects to an external device the ESN and Linkstring are loaded and, as will be explained below, are used to identify and certify the IDTP. After the ESN and Linkstring have been retrieved by the application program any error codes present in the IDTP are retrieved at Fetch Error Code step 4027. Another novel and useful feature of the present invention is that when an error occurs it is assigned an error number and stored in the memory of the IDTP. Thus when a user attaches the IDTP to their PC, the cause of that error is displayed on the user's PC so that the user may know what action to take to resolve the situation.

Once any error codes have been retrieved and stored, the process enters the Display Welcome Screen step 4028 where the Welcome screen is presented to the user. FIG. 9 provides an example of the welcome screen used in a preferred embodiment of the present invention. Note that the Welcome screen is part of the overall program 4000. The Welcome Screen 6000 has the look and feel of a contemporary user screen and performs according to contemporary rules. A series of tabs is provided that allow the user to choose some activity or another. The CellStik Edit tab 6100 is used to direct the user to the edit function of the application program. In a similar manner the Compatible Phones tab 6200 sends the user to a list of compatible cell phones, the Check for Updates tab 6300 links the user to a sub program that permits the user to determine if their IDTP needs firmware or software updates, the Transfer Phonebook tab 6400 directs the user to a function that allows the phonebook of one IDTP to be transferred to another IDTP, and the Help & Support tab 6500 provides assistance to the user for solving problems or answering commonly asked questions. The Exit tab 6010 is used to terminate application program operations and operates according to customary principles. Once the Welcome Screen has been displayed the Display User Message step 4030 prompts the user to select one of the tabs just described. Process flow then progresses to the tab selection tree shown in FIG. 8B via off page connector 6 4032.

Referring to FIG. 8B, process flow enters via off page connector 6 4032 and enters the Edit decision 4034. If the user selects the CellStik Edit tab 6100 the process branches to FIG. 8C via off page connector 7 4036. If the user does not select the edit function, the No path is followed out of Edit decision 4034 and enters the Compatible Phones decision 4038. If the user selects the Compatible Phones tab 6200 the process branches to FIG. 8E via off page connector 8 4040. If the user does not wish to check compatible phones, the No path is followed out of Compatible Phones decision 4038 and enters the Update decision 4042. If the user selects the Check for Updates tab 6300 the process branches to FIG. 8H via off page connector 9 4044. If the user does not wish to update his/her IDTP, the No path is followed out of Update decision 4042 and enters the Transfer decision 4046. If the user selects the Transfer Phonebook tab 6400 the process branches to FIG. 8I via off page connector 11 4048. If the user does not wish to use the transfer function, the No path is followed out of Transfer decision 4046 and enters the Help decision 4050. If the user selects the Help & Support tab 6500 the process branches to FIG. 8J via off page connector 12 4052. If the user does not wish to use the help function, the No path is followed out of Help decision 4050 and the process returns to Edit decision 4034. In this way the process loops on the tab selection tree until the user either selects a function or exits the application program by selecting the Exit tab 6010.

Looking at FIG. 8C, and assuming the user has selected the CellStik Edit tab 6100, the process enters at off page connector 7 4036 where the Edit Screen 6100 is displayed which contains an Open Edit tab 6120 as shown in FIG. 10A. The user selects this tab and the Edit Window Screen 6150 is displayed as shown in FIG. 10B. At this point the user is able to manipulate the data that has been downloaded to the PC memory from the IDTP memory. For example, by selecting the Save to CellStik icon 6155 the data that have been edited are transferred to the IDTP. If the user wishes to add, edit, delete or print the data, the relevant icons 6160, 6165, 6170, and 6175 respectively are selected. And if the user needs help or wants some support information, the Help icon 6180 may be selected. As with all user screens, if the user wishes to exit the edit function the Exit tab 6185 may be selected which takes the user back to the main Edit screen. Note that data are entered, edited and deleted in the customary manner thus no detailed discussion is provided here.

Looking again at FIG. 8C, and recalling that the process enters at off page connector 7 4036 the process flow enters the Data decision 4110. If the IDTP that has been attached to the PC has no data in memory, the process takes the No branch out of the Data decision 4110 where the process posts a message to the user at Display User Message 4120 instructing the user to first populate the IDTP memory with data. Process flow then returns to the End step 1080 via off page connector 1 1070. Once the user has populated the memory of the IDTP the process may be restarted. But suppose now that the IDTP does have data in its memory, the Yes path is followed out of Data decision 4110 to the Open Data File step 4130. This step is used to establish access from the PC to the memory of the IDTP. The process advances to the User Edits Data step 4135 where the user edits the data. Note that the editing task is accomplished in the conventional way so is not discusses here for clarity. However, lack of a detailed discussion should not be read as a limitation on the scope of the invention.

At Exit decision 4140 the process determines if the user has selected the Exit tab (6185 of FIG. 10B). If not, process flow advances to the Save decision 4170, discussed just below. If the user did wish to exit the edit screen, the Yes path is followed out of Exit decision 4140 and flow passes to the Change Since Last Save decision 4150. If no changes have been made since the last save, the program returns the tab selection tree via off page connector 6 4032. However, if changes have been made, the user is notified at Display User Message 4160 and the flow advances to the Save decision 4170. If the user then wishes to exit without saving the changes the No path is followed out of Save decision 4170 and the program returns the tab selection tree via off page connector 6 4032. If the user does wish to save the changes the Yes path is followed leading to the Save Process of FIG. 8D via off page connector 14 4180.

Looking at FIG. 8D and supposing the user selects the Yes response to Save decision 4170 the process passes to the IDTP Plugged decision 4210 in FIG. 8D via off page connector 14 4180. At IDTP Plugged decision 4210 the method of the present invention again checks to be sure that a device is attached to the PC. This is done because for some operations, as explained below, it is necessary for the user to remove the IDTP. If a device is not present, the No path is followed out of IDTP Plugged decision 4210 to Display User Message step 4220 where the user in instructed to reattach an IDTP device. The process then loops back until a device is detected. If a device is present the Yes path is followed out of IDTP Plugged decision 4210 to the Model & Manufacturer OK decision 4230. Here the model and manufacturer data are read in the same way as discussed in conjunction with FIG. 7A. If the data are good the process advances to the Write Data to IDTP step 4240. Once the data are done being written the process returns to tab selection tree of FIG. 8B via off page connector 6 4032.

However if the model and manufacturer data were not correct the Display User Message step 4260 is executed to inform the user that a different IDTP has been attached. This could happen, as explained below, as the result of the process of converting between two IDTPs that are compatible with different cell phones. At Save Anyway decision 4270 if the user wishes to save the data the Yes path is followed leading to the Write Data to IDTP step 4270. If the user did not wish to save the data, the No path is followed out of Save Anyway decision 4270 where process control passes to the tab selection tree of FIG. 8B via off page connector 6 4032.

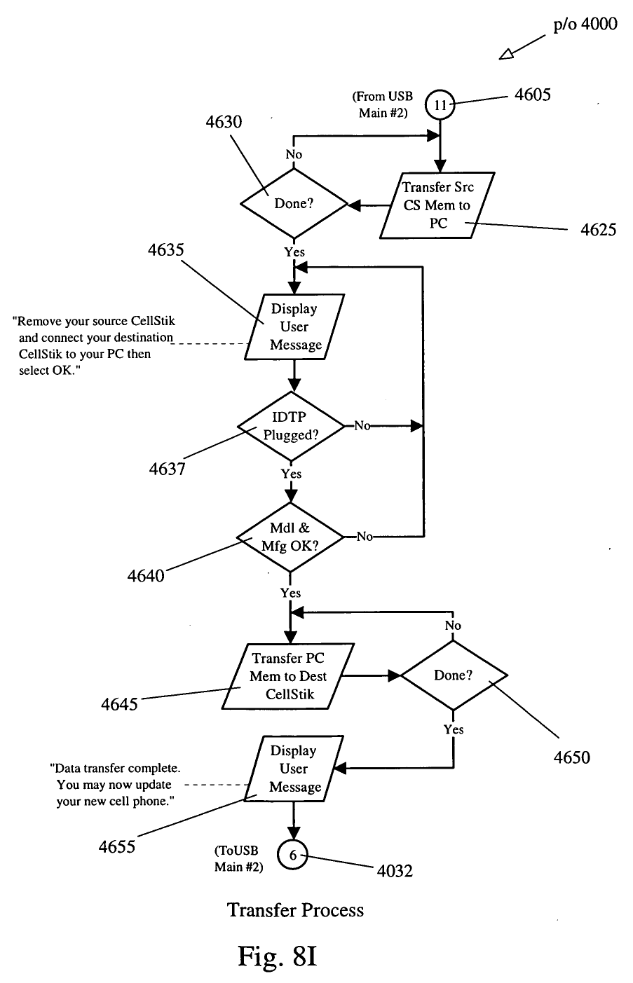

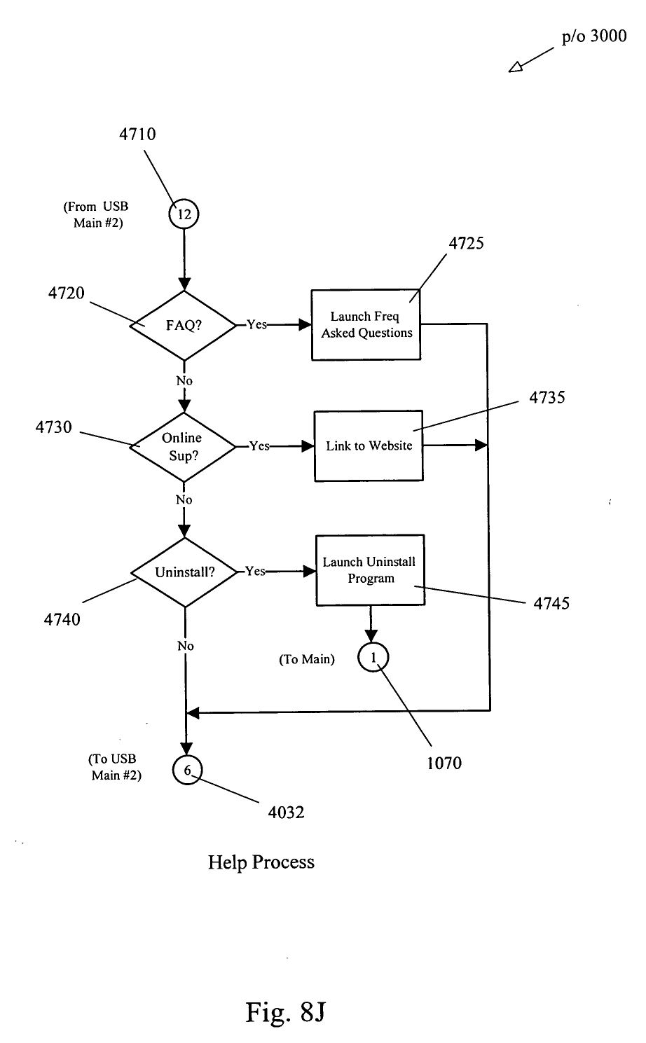

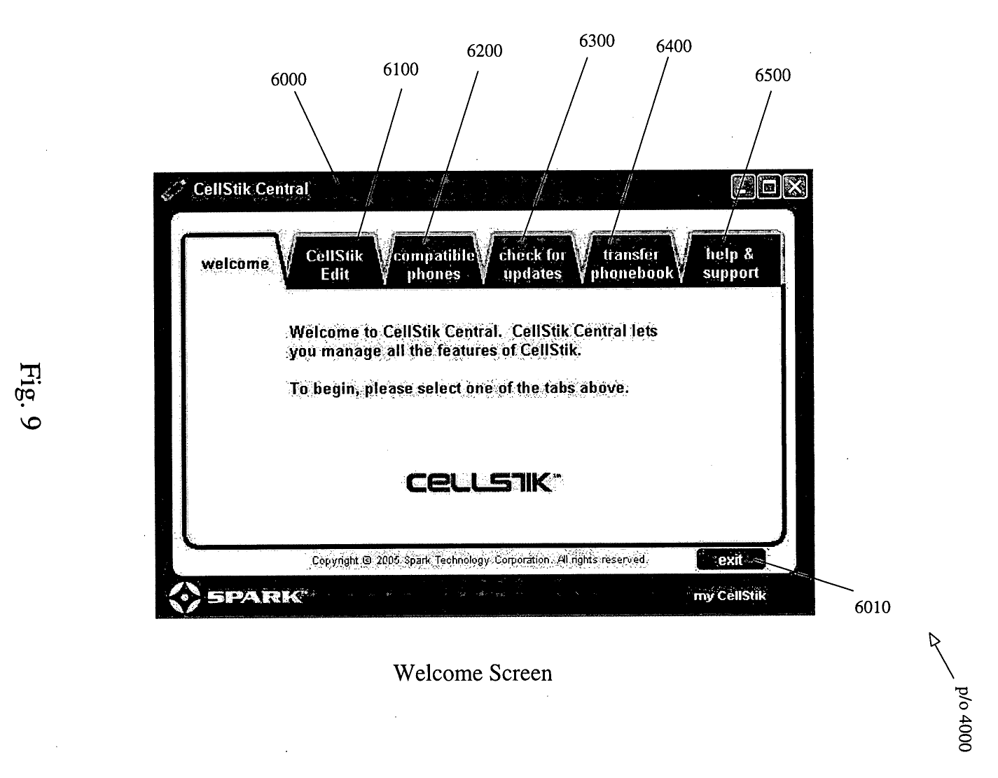

Next assume that the user has selected the Compatible Phone tab 6200 from the Welcome Screen 6000. Recall from above that the process branches to FIG. 8E via off page connector 8 4040. The Compatible Phones Screen is displayed as shown in FIG. 11A. At Write Supported Phones to Screen step 4310 a list of phones is provided to the user for review. If the phone is supported, for example the Samsung™ SCH-A670, the user may select the Exit tab 6210 to exit the application program or may simply select one of the other tabs. But suppose that the required phone is not supported. In this case the process posts a message to the user at Display User Message step 4320 instructing the user to select the Add Cell Phone tab 6220. If the user selects the Add Cell Phone tag 6220 process flow follows the Yes path out of Add Phone decision 4330 to the Upgrade Process of FIG. 8F via off page connector 15 4350. If the user does not select the Add Cell Phone tab 6220 process flow returns to the tab selection tree of FIG. 8B via off page connector 6 4060. One of the advantages of the present invention is the ease with which additional phones may be added to the list of those supported.

FIG. 11B shows the Upgrade Screen 6250. The user arrived at this screen as the result of selecting the Add Cell Phone tab 6220. It should be noted that this screen is a web page that was linked to by the application program, thus if the user arrived at this screen by accident, simply closing the window in the customary manner places the user back at the tab selection tree of FIG. 8B. The Upgrade Screen 6250 provides the user with a list of currently supported cell phones 6252, a list of cell phones that can be added at no charge 6254 and a list of cell phones that are supported but require the user to be charges a fee 6256. If the user chooses to add cell phone support, they simply populate the data area provided and select the Send Request tag 6258. The upper right hand area of the Upgrade Screen 6250 is used to display user data 6260 and to provide a way to correct or change that data 6262.

Looking at FIG. 8F the process for upgrading or adding a cell phone is described in detail. Entry into the process is via off page connector 4350 where the Fetch Current Data step 4403 is executed. As mentioned above in the discussion of FIG. 8A, at Fetch Current Data step 4403 the method of the present invention retrieves the user's current data including the PCP (Previous Cell Phone,) CCP (Current Cell Phone,) FW (Firmware) revision, and CSP (Cell Phone Service pack) along with other data to be used in determining if the cell phone to be added is compatible or whether an update will be required. At No PCP decision 4406 the process determines if there was a previous cell phone used. If so, the Yes path is followed out of No PCP decision 4406 to the CCP=PCP decision 4409. This decision is to determine if the user's data already contains the necessary information for adding this cell phone.

If the CCP and the PCP match the Yes path is followed out of CCP=PCP decision 4409 to the Write CCP Field step 4421. Returning to No PCP decision 4406, and assuming that no PCP exists or, alternatively, that the PCP was not equal to the CCP, the process enters the CCP/PCP Support decision 4412. If the data show that the CCP and PCP are supported the Yes path is followed out of the CCP/PCP Support decision 4412 to the Write CCP Field & PCP Field 4418. Lastly, if the PCP and/or CCP are not supported the No path is followed out of CCP/PCP Support decision 4412 to the Display User Message step 4415 where a list of those phones that are supported is displayed to the user. The user selects one of the phones listed and the flow progresses to the User Selects Model or Accepts Default step 4424. The combination of the three branches of the process comprised of No PCP decision 4406, CCP/PCP Supported decision 4412 and Display User Message 4415 form a auto-complete subroutine that populates a data base used by the method of the present invention to determine what the required combination of software, firmware and on-line support is for the cell phone to be added.

From the User Selects Model or Accepts Default step 4424 the process enters the FW/CSP Support decision 4427. If the cell phone selected is not supported the process advances to the Registration Data>3 decision 4451 via off page connector 16 4430. If this path is followed additional upgrade selections will need to be made as discussed in detail below. However, if the selected cell phone is supported the Yes path is followed out of FW/CSP Support decision 4427 to the FW/CSP OK decision 4433. Here the method of the present invention determines if the current levels of firmware and cell phone service pack data retrieved above are current. If so, the Yes path is followed out of FW/CSP OK decision 4433 to the Display User Message step 4436 where the user is informed that their cell phone is supported and their IDTP is up to date. The process then transfers to the tab selection tree of FIG. 8B via off page connector 6 4032.

Considering now that the firmware or cell phone service pack were not current, the No path is followed out of FW/CSP Support decision 4433 to the Display User Message step 4439 where the user is informed that the selected cell phone is supported but that an update is required. At Upgrade decision 4442 the user is given the opportunity to either perform the upgrade or not. If the user chooses not to upgrade, flow passes back to the tab selection tree of FIG. 8B via off page connector 6 4032. If the user does wish to upgrade the Yes path is followed out of Upgrade decision 4442 to the Fetch Current FW/CSP step 4445. The process then enters the Link User to Download Area step 4448 where the Download Screen 6350 shown in FIG. 11B is shown. Off page connector 17 4460 is used to return the process flow from other portions of the process.

Returning to FW/CSP Supported decision 4427, and assuming that the user's firmware or Cell phone Service Pack is/are out of date, recall that as described above the flow now passes to FIG. 8G to the Registration Data>3 decision 4451 via off page connector 16 4430. If the user registered their IDTP less than three months previous, the upgrade is delivered at no charge, thus the Yes path is followed out of Registration Data>3 decision 4451 and passes to the Fetch Current FW/CSP step 4445 via off page connector 17 4460. From there the process progress as described above.

If, on the other hand, the user registered their IDTP greater than three months previous process flow passes to the Additional Upgrade decision 4454. If the user purchased additional upgrades previously, the Yes path is followed out of Additional Upgrade decision 4454 and the process progresses to the Fetch Current FW/CSP step 4445 via off page connector 17 4460. If the user has not purchased additional upgrades, but wishes to do so at this time, the No path is followed out of Additional Upgrade decision 4454 to the Display User Message step 4457 where the user is prompted to make a choice to either purchase or decline to purchase. If the user opts to purchase an upgrade the Yes path is followed to the Update User Registration Information step 4466. Inside this subroutine the user provides the requisite purchase information and, when completed, the flow then passes to the Fetch Current FW/CSP step 4445 via off page connector 17 4460. If the user declined the invitation the purchase the upgrade flow follows the No path out of the Purchase? decision 4463 and returns control to the tab selection tree of FIG. 8B via off page connector 6 4032.

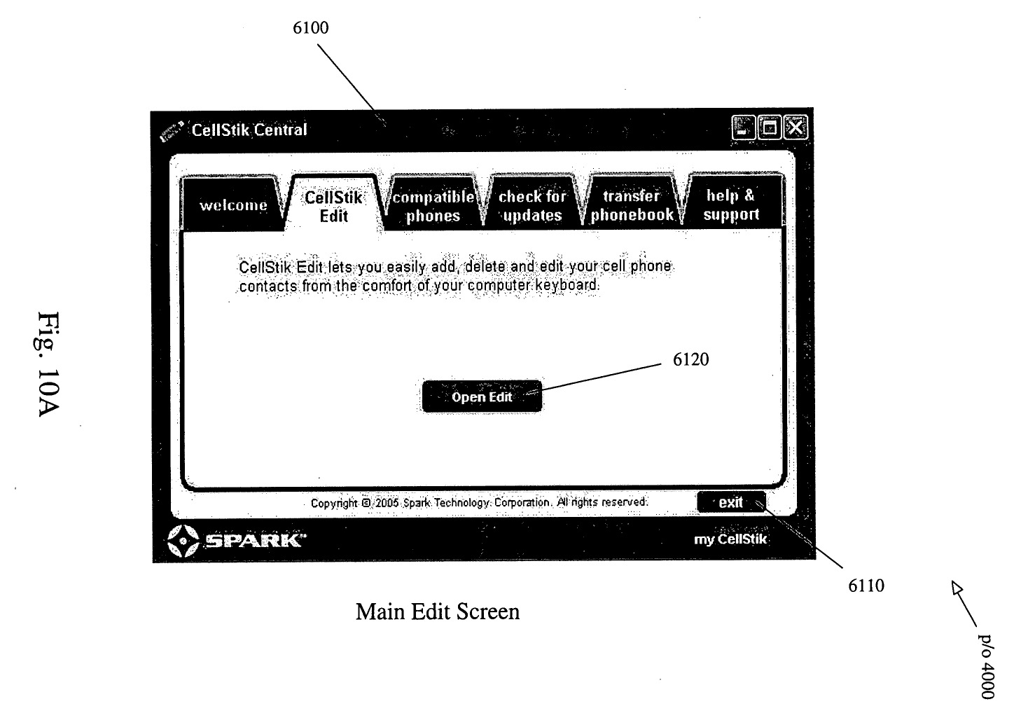

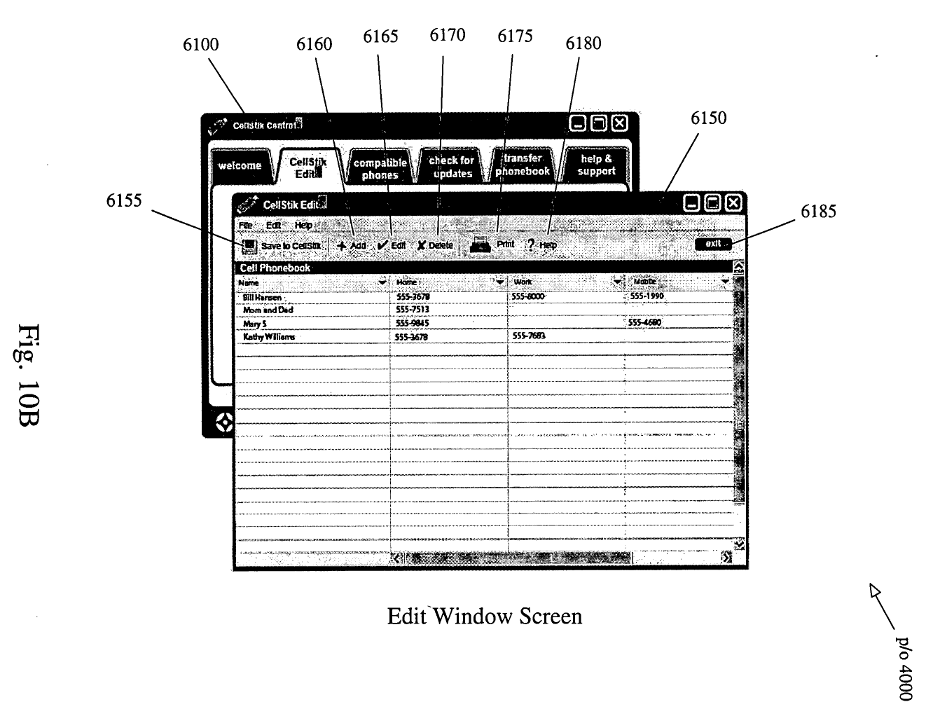

Recall from above that the method of the present invention has checks that determine the current status of the application software running of the PC and the firmware resident in the IDTP. FIG. 8H shows the details of the process flow for determining which of the updates need to be sent to the user while FIGS. 12A and 12B provide details of the screens used for the upgrade process. Looking first at the screens, and referring to FIG. 12A, if the user selected the Check for Updates tab the Main Update Screen 6300 is displayed. If the user wishes to check for updates, the Check for Updates tab 6320 is selected. If the user wishes to exit the application program the Exit tab 6310 is selected in the same manner as discussed with other screens above.

Having selected the Check for Updates tab 6320 the Update Download Screen 6350 appears as shown in FIG. 12B. If the user has been informed that an update is available the Get Update tab 6360 is selected which launches the download process. Since the download is accomplished in the customary manner no detailed discussion is provided here. If a firmware update has been suggested, the CellStik Firmware Update tab 6370 is selected causing the firmware update to be downloaded in a manner similar to the other downloads already discussed. If the user's IDTP is up to date, the user message 6375 is displayed. Since this is a linked web page, similar to the Upgrade screen from above, if the user wishes to exit, he/she simply closes the window in the usual manner.

Looking now at FIG. 8H, the update process enters the Fetch Current Data step 4505 via off page connector 9 4044. The Fetch Current Data step 4505 accomplishes the same data retrieval in the same manner as discussed above. At CC/EDT Old decision 4535 the method of the present invention determines if the either the core software application or the edit function of the application running on the user's PC is current. If not, flow passes to the FW Old decision 4545. If either the core software application or the edit function of the application is old the Yes path is followed out of CC/EDT Old decision 4535 to the Download CC/EDT S/W step 4540. Once the proper download has completed, flow passes back to the tab selection tree of FIG. 8B via off page connector 6 4032.

Returning to the FW Old decision 4545, suppose the firmware of the user's IDTP is out of date. The Yes path is followed to the Download Firmware step 4550 where the current firmware code is download in a manner similar to the software code just above. As with the software download, once complete flow passes back to the tab selection tree of FIG. 8B via off page connector 6 4032. If the user's IDTP firmware was not out of date, the No path out of FW Old decision 4545 is followed leading to the Display User Message step 4555 and from there flow passes back to the tab selection tree of FIG. 8B via off page connector 6 4032.

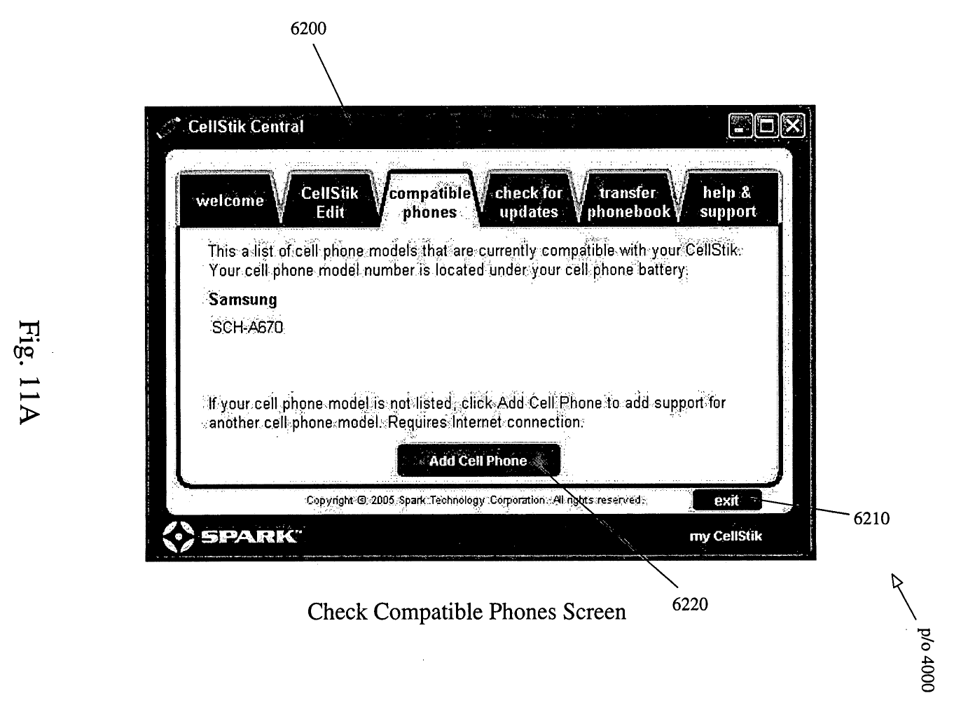

Consider now that the user selected the Transfer Phonebook tab on Welcome Screen 6000. FIG. 8I is a flow chart of the transfer process. When the user selects the Transfer Phonebook tab 6400 the Transfer Screen of FIG. 13 is shown. The user selects the Transfer tab 6420 to begin the process. Of course if the user to end the application program, the Exit tab 6410 can be selected.

The transfer process enters the Transfer Source CellStik Mem to PC step 4625 via off page connector 11 4605. The operation of transferring the data from the source IDTP to PC memory begins after the user has selected the Transfer tab 6420. The method of the present invention monitors the process and continues to transfer data until the last record has been transferred. This transfer is accomplished in the same manner as described earlier in conjunction with FIG. 7, so is not repeated here for clarity. The Done decision 4630 remains false until the last record has been transferred, following the No path back to the Transfer Source CS Memory to PC step a 4625. Once the last record has been transferred the Done decision 4630 becomes true and the Yes path is followed leading to the Display User Message step 4635 where the user is directed to disconnect the source IDTP and connect the destination IDTP.

At IDTP Plugged decision 4637 if the user has not yet connected the destination IDTP, the process returns to the Display User Message step 4635 via the No path out of IDTP Plugged decision 4637, looping until the proper action has been taken. At the Model & Manufacture OK decision 4640 the process has determines if the destination IDTP is the correct type and if so, if it is ready to receive data. If not the No path is followed out of Model & Manufacture OK decision 4640, returning to the Display User Message step 4635 via the No path out of IDTP Plugged decision 4637, looping until the proper action has been taken. If the proper IDTP has been connected and is ready to receive data, the data are sent to the destination IDTP at Transfer PC Memory to Destination CellStik step 4645.

As above, until the last record has been transferred the operation continues executing a loop consisting of the Done decision 4650 and Transfer PC Memory to Destination CellStik step 4645 until the transfer is complete. At that time the process follows the Yes path out of Done decision 4650 to the Display User Message step 4655 where the user is informed that the transfer is complete. From there the process returns to the tab selection tree via off page connector 6 4032.

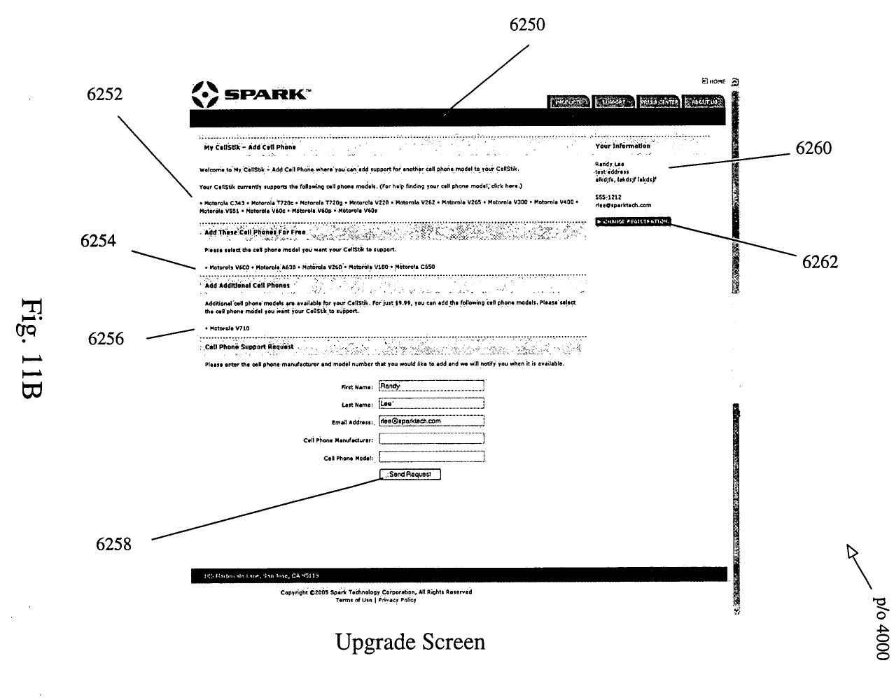

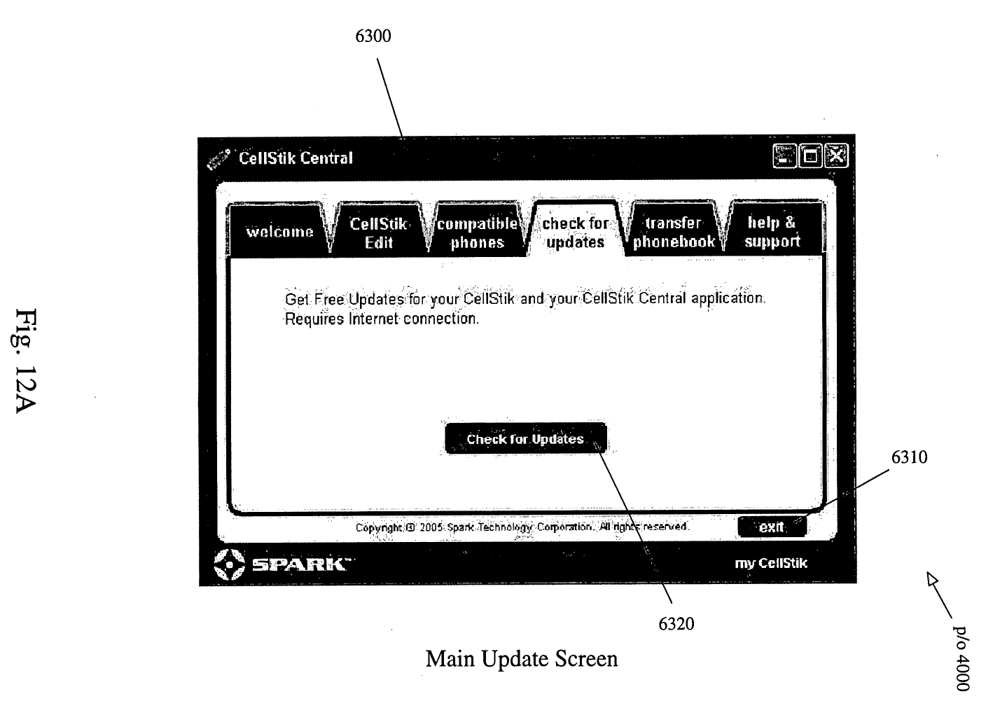

The last tab that could be selected by a user from the Welcome Screen 6000 is the Help & Support tab 6500. FIG. 14 shows the Help Screen as it appears when the Help & Support tab 6500 is selected. As with previous screens, if the user wishes to terminate the application program the Exit tab 6510 may be selected. Three other actions may be selected by the user. These include selecting the Frequently Asked Questions tab 6520, selecting the Help & Support Online tab 6530 and selecting the Uninstall CellStik Central tab 6540. Each of these is discussed below in conjunction with FIG. 8J.

The help process is entered at the FAQ decision 4720 via off page connector 12 4710. If the user has selected the Frequently Asked Questions tab 6520 the current listing of those questions is displayed for the user at Launch Frequently Asked Questions step 4725. If the user did not select the frequently asked questions the No path is followed out of FAQ decision 4720 and process flow enters the Online Support decision 4730. If the user selected online support, the yes path leads to the Link to Website step 4735. The user is passed to the website where instructions and help may be found. If the user did not select online support the No path is followed out of Online Support decision 4730 to the Uninstall decision 4740. If the user wishes to uninstall the software application resident on his/her PC the Launch Uninstall Program 4745 is executed. If either the frequently asked questions or online support tasks were selected by the user, when complete control passes back to the tab selection tree of FIG. 8B via off page connector 6 4032. However, in the case of the uninstall task, once the software has been removed the process ends at the End step 1080 via off page connector 1 1070.

Other functions are incorporated into the application software executing on the user's PC but are not discussed in detail since they do not directly impinge in the method of the present invention. Such functions include registration of new users, management of user data, financial processing and vendor notifications. These functions perform in a manner consistent with other conventional programs. The absence of a detailed discussion of these functions should not be read as a limitation on the scope of the invention.

Up to this point in the discussion the various processes have assumed the availability of a PC and the Internet to accomplish tasks involving changing cell phone models or manufacturers. But what if the user is in an area that lacks access to the Internet or where it is difficult to get to and use a PC? One of the more advantageous improvements of the present invention is a method that allows transfer, saving and backup of data contained in one cell phone to another cell phone without the need to connect to an external device such as a PC.

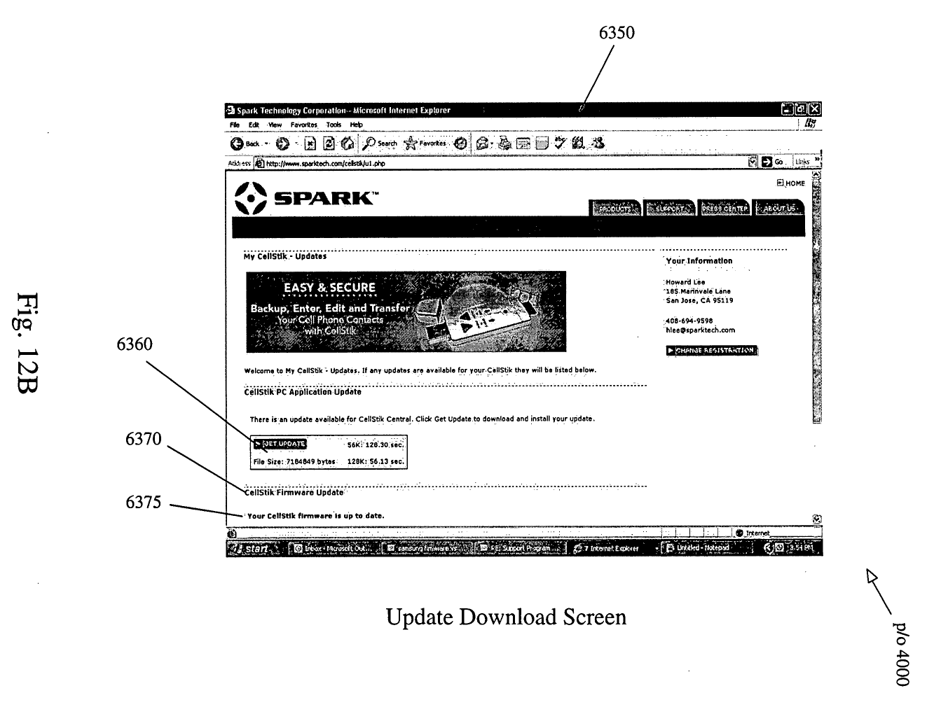

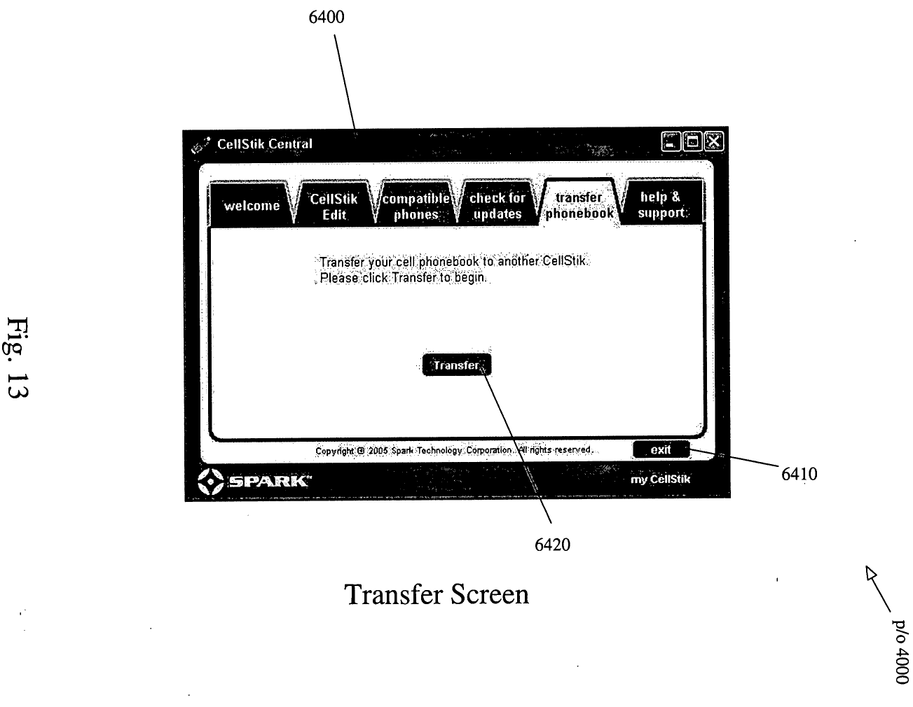

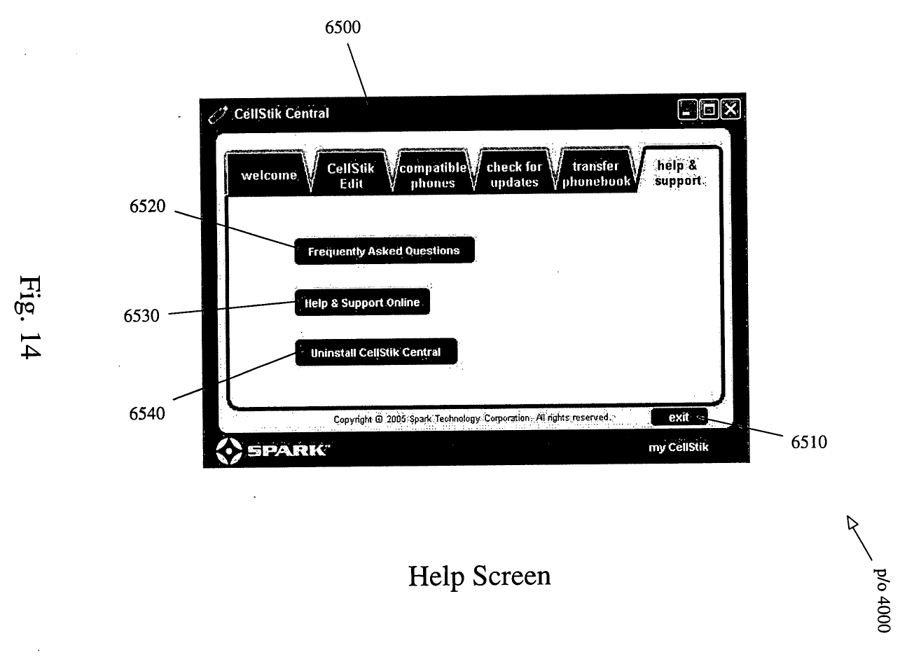

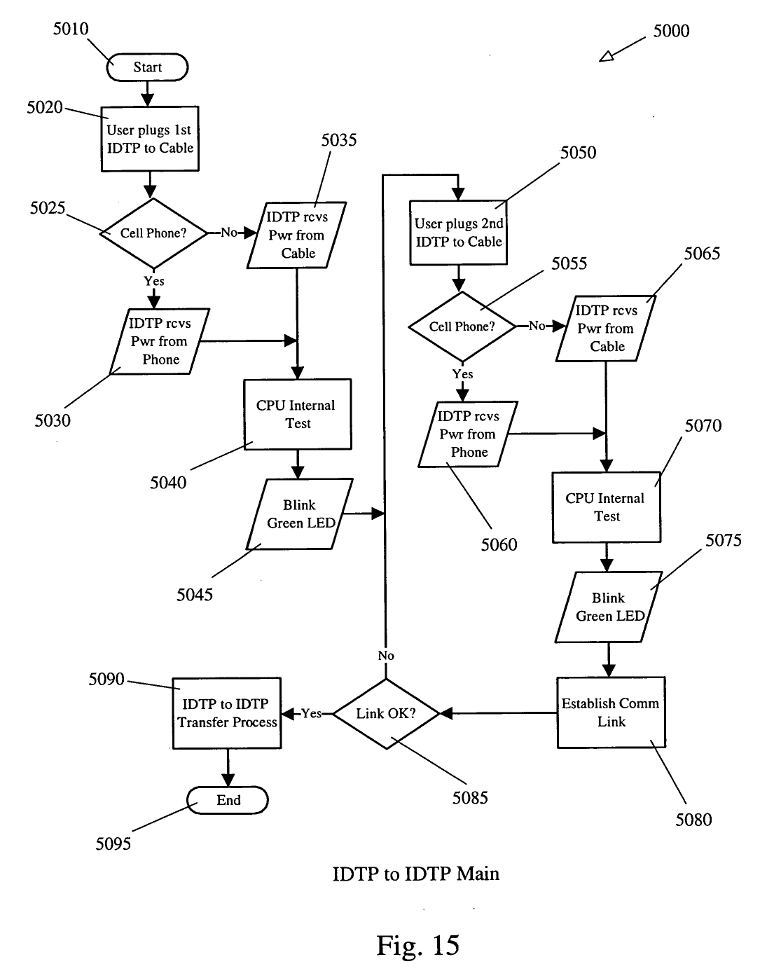

FIG. 15 provides a flow chart 5000 describing the method for moving data between two cell phones without the need for an external device such as a PC. The process is entered at the Start step 5010. The user plugs a first IDTP compatible with a first cell phone into a custom transfer cable, described below in greater detail, at User Plugs 1^{st} IDTP to Cable step 5020. At Cell Phone decision 5025 the process determines if the user has plugged the IDTP into a cell phone as well. This is important because there exist a plurality of transfer configurations, each providing power to the IDTP in a different way. If the user has not plugged into a cell phone, the No path is followed out of Cell Phone decision 5025 to the IDTP Receives Power from Cable step 5035. If the user has plugged into a cell phone, the Yes path is followed out of Cell Phone decision 5025 to IDTP Receives Power from Phone step 5030.

In either case once power has been applied the IDTP performs an internal test to determine that the IDTP is operational at CPU Internal Test step 5040. This test is the same as was described above in conjunction with FIG. 5 thus is not repeated here for clarity. Upon successful CPU test but prior to executing other internal checks, the green LEDs are set to blink at Blink Green LED step 5045. Once the entire boot process is complete the green LEDs are turned off.

Process flow now progress to User Plugs 2^{nd} IDTP to Cable step 5050 where the user plugs a second IDTP compatible with a second cell phone into a custom transfer cable, described below in greater detail. At Cell Phone decision 5055 the process determines if the user has plugged the IDTP into a second cell phone as well. This is important for the same reason stated just above. If the user has not plugged into a cell phone, the No path is followed out of Cell Phone decision 5055 to the IDTP Receives Power from Cable step 5065. If the user has plugged into a cell phone, the Yes path is followed out of Cell Phone decision 5055 to IDTP Receives Power from Phone step 5060.

As was the case for the first IDTP above, once power has been applied the second IDTP performs an internal test to determine that it is operational at CPU Internal Test step 5070. This test is the same as was described above in conjunction with FIG. 5 thus is not repeated here for clarity. Upon successful CPU test but prior to executing other internal checks, the green LEDs are set to blink at Blink Green LED step 5075. Once the entire boot process is complete the green LEDs are turned off.

Upon completing the power up and test of both IDTPs, the process senses a connection and creates a communication session at Establish Communication Link step 5080. The exact process for doing this is not discussed in detail since it is done using conventional serial communications methods. At Link OK decision 5085 the method determines if the communications link has been properly established. If not, the No path is followed out of Link OK decision 5085 reentering the User Plugs 2^{nd} IDTP to Cable step 5050. The method of the present invention will continue to loop in this manner until a proper communication link has been established. When a proper link has been established the process enters the IDTP to IDTP Transfer Process step 5090.

Once the transfer is complete the process enters the End step 5095 where the user disconnects the IDTPs and the process stops. The details of the transfer process, whether saving data to a cell phone or backing data up to an IDTP, are identical to the same processes discussed above in conjunction with FIGS. 7A, 7B and 7C thus are covered here.

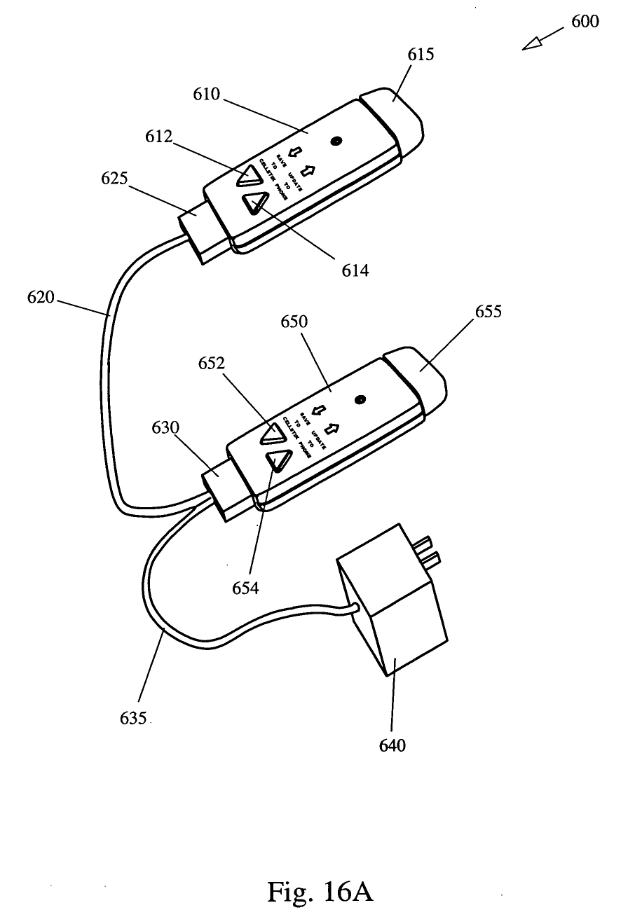

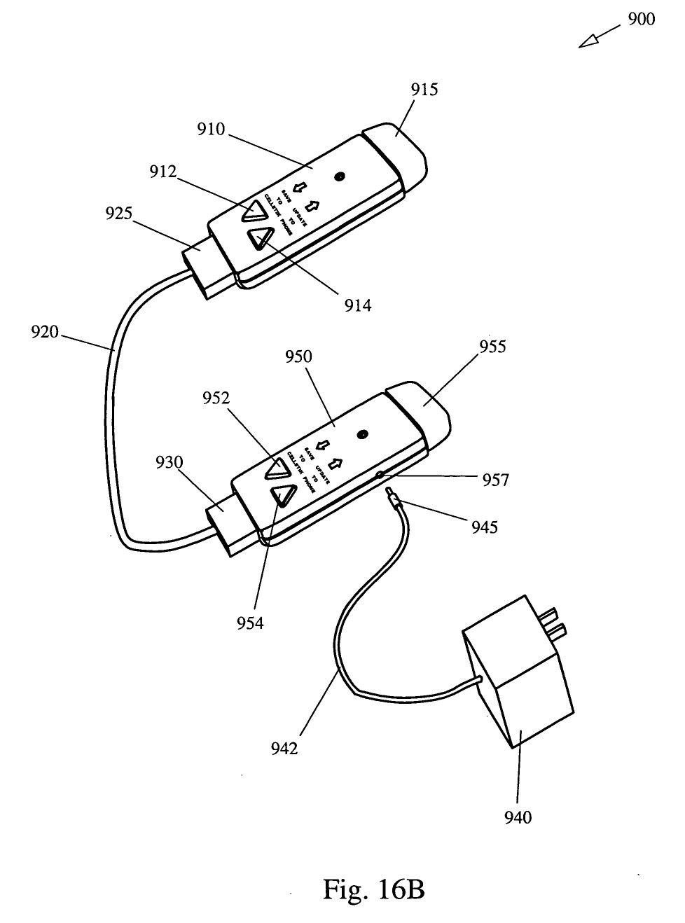

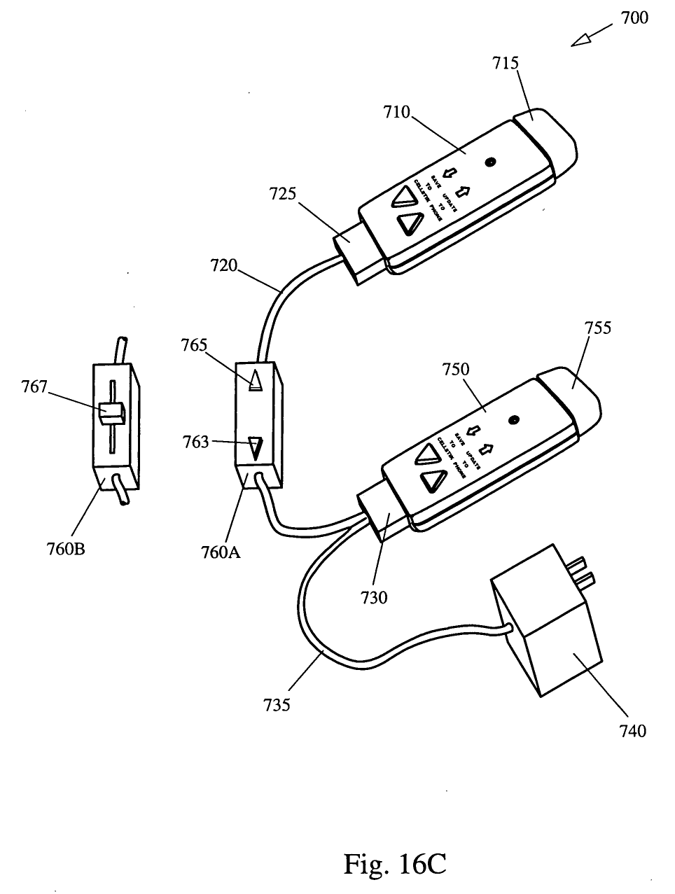

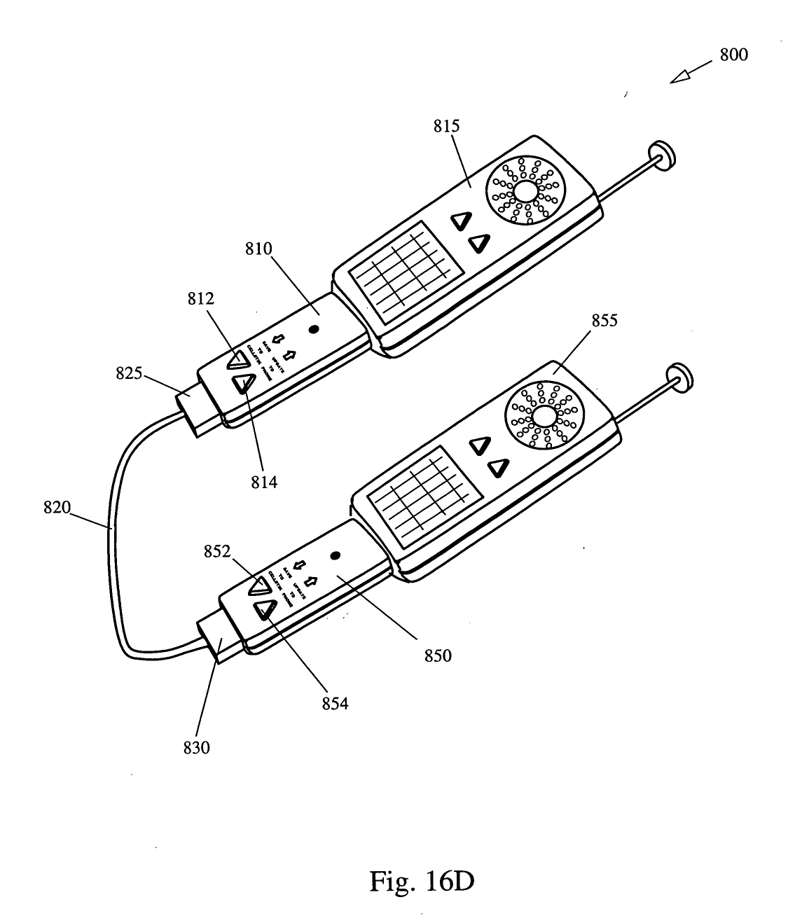

Turning now to FIGS. 16A, 16B, 16C and 16D, four embodiments of an apparatus that may be used to implement the IDTP to IDTP transfer method described just above are shown. FIGS. 16A, 16B and 16C illustrate cable powered configuration while FIG. 16D illustrates a cell phone powered configuration.

Beginning with FIG. 16A a cable powered configuration 600 is shown. A first IDTP 610 is connected directly to a second IDTP 650 via a custom cable 620. The cell phone connector of IDTP 610 is covered by cap 615. The connector on the opposite end of IDTP 610 mates with connector 625 which is part of cable 620. In a like manner the cell phone connector of IDTP 650 is covered by cap 655. The connector on the opposite end of IDTP 650 mates with connector 630 which is part of cable 620. Cable extension 635 terminates in a power supply 640 suitable for plugging into standard AC current. This power supply is of the contemporary type and is not discussed in detail here. Further, although the power supply 640 is shown to be compatible with 115 VAC circuits it will be recognized that other sources of AC could be used without departing from the spirit of the invention.

In operation, the method of the invention is executed when a user presses one of the directional buttons on either IDTP 610 or IDTP 650. For example, if the user wished to move the contents of the memory in IDTP 610 to IDTP 650, button 612 would be depressed. If, on the other hand, the user wished to move data from IDTP 650 to IDTP 610, button 614 would be depressed. Buttons 652 and 654 on IDTP 650 perform the exact same functions in the exact same manner as their counterparts on IDTP 610.

FIG. 16B shows a second preferred cable powered configuration 900. A first IDTP 910 is connected directly to a second IDTP 950 via a custom cable 920. The cell phone connector of IDTP 910 is covered by cap 915. The connector on the opposite end of IDTP 910 mates with connector 925 which is part of cable 920. In a like manner the cell phone connector of IDTP 950 is covered by cap 955. The connector on the opposite end of IDTP 950 mates with connector 930 which is part of cable 920. Cable 942 has a power plug 945 suitable for insertion into power jack 957 on IDTP 950 on one end and terminates in a power supply 940 suitable for plugging into standard AC current on the opposite end. This power supply is of the contemporary type and is not discussed in detail here. Further, although the power supply 940 is shown to be compatible with 115 VAC circuits it will be recognized that other sources of AC could be used without departing from the spirit of the invention.

In operation, the method of the invention is executed when a user presses one of the directional buttons on either IDTP 910 or IDTP 950. For example, if the user wished to move the contents of the memory in IDTP 910 to IDTP 950, button 912 would be depressed. If, on the other hand, the user wished to move data from IDTP 950 to IDTP 910, button 914 would be depressed. Buttons 952 and 954 on IDTP 950 perform the exact same functions in the exact same manner as their counterparts on IDTP 910.

Looking now at FIG. 16C an alternative cable powered configuration 700 is shown. A first IDTP 710 is connected to a second IDTP 750 via switch housing 760A which is part of a custom cable 720. The cell phone connector of IDTP 710 is covered by cap 715. The connector on the opposite end of IDTP 710 mates with connector 725 which is part of cable 720. In a like manner the cell phone connector of IDTP 750 is covered by cap 755. The connector on the opposite end of IDTP 750 mates with connector 730 which is part of cable 720. Cable extension 735 terminates in a power supply 740 suitable for plugging into standard AC current. This power supply is of the contemporary type and is not discussed in detail here. Further, although the power supply 740 is shown to be compatible with 115 VAC circuits it will be recognized that other sources of AC could be used without departing from the spirit of the invention.

In operation, the method of the invention is executed when a user presses one of the directional buttons on switch housing 760A. For example, if the user wished to move the contents of the memory in IDTP 710 to IDTP 750, button 763 would be depressed. If, on the other hand, the user wished to move data from IDTP 750 to IDTP 710, button 765 would be depressed. In still another alternative embodiment a switch housing 760B is used. In this configuration a slider switch 767 has a neutral position as well as two active positions. Moving the slider switch 767 to the end of the switch housing 760B nearest IDTP 710 will cause the contents of the memory of IDTP 750 to be copied to the memory of IDTP 710. In a similar manner, moving the slider switch 767 to the end of the switch housing 760B nearest IDTP 750 will cause the contents of the memory of IDTP 710 to be copied to the memory of IDTP 750.

FIG. 16D shows a fourth embodiment 800 for moving the memory contents of a first cell phone 815 to a second cell phone 855 or vice versa. This configuration could be used, for example, when a user changes the manufacturer or model of their cell phone and does not have the capability to use an external device such as a PC to assist in the data transfer. A first cell phone 815 is connected to IDTP 810 by way of its cell phone connector (not shown). The connector on the opposite end of IDTP 810 mates with connector 825 which is part of cable 820. Custom cable 820 then connects to a second IDTP 850 via connector 830. In a like manner the cell phone connector of IDTP 855 is connected to IDTP 850 by way of its cell phone connector (not shown). The connector on the opposite end of IDTP 855 mates with connector 830 which is part of cable 820.

In operation, the method of the invention is executed when a user presses one of the directional buttons on either IDTP 810 or IDTP 850. For example, if the user wished to move the contents of the memory in first cell phone 815 to a second cell phone 855, button 812 on IDTP 810 would be depressed. If, on the other hand, the user wished to move data from second cell phone 855 to a first cell phone 815 button 814 on IDTP 810 would be depressed. Buttons 852 and 854 on IDTP 850 perform the exact same functions in the exact same manner as their counterparts on IDTP 810.

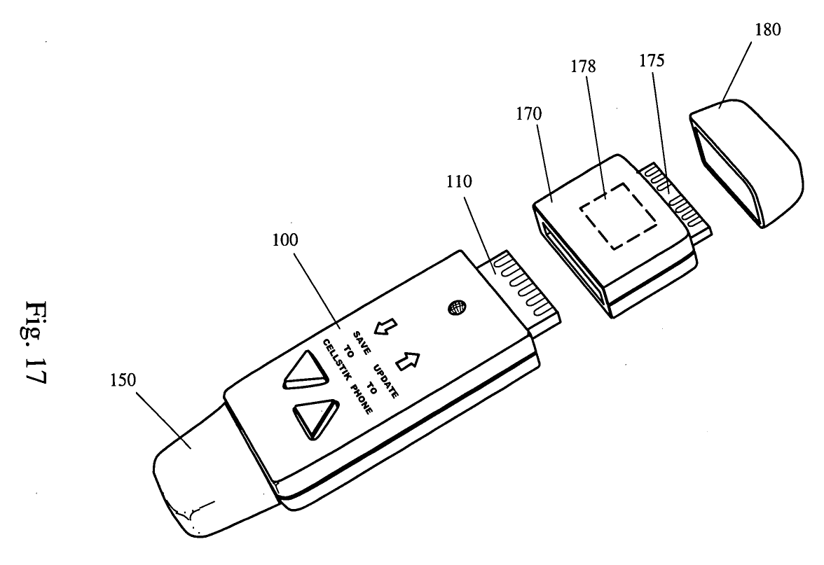

Looking now at FIG. 17, a preferred embodiment of the apparatus 100 of the present is shown. The main body of the apparatus 100 contains the CPU (200 of FIG. 2), the memory (500 of FIG. 2) and all the necessary auxiliary electronics and user control, also shown in detail in FIG. 2. An end cap 150 covers the USB Connector (120 of FIG. 2). When the user wishes to interface to an external digital device such as a PC, the end cap 150 is removed. Once the user has completed the process the cap 150 is replaced to protect the pins of the connector.

At the opposite end of the main body of the apparatus 100 the Cell Phone I/O 110 receives signals from the CPU 200. Cell Phone I/O connector 110 mates with MAA 170. Recall that in the embodiment of the apparatus of the present invention shown in FIG. 2, the MAA was an integral part of the electronics contained within the main body (MAA 114 in FIG. 2). In this preferred embodiment the MAA 170 is detachable from the main body of the apparatus 100. There exist a plurality of MAAs 170, each with a Cell Phone connector 175 and a satellite memory 178 that is compatible with different cell phone manufacturers and models. Satellite memory 178 is a AT45 DB011B from Atmel Corporation, San Jose, Calif. in a preferred embodiment. The size of the memory depends on the exact cell phone model, but it will be understood that other types of memory with varying size could be used without departing from the spirit of the invention. The size of the memory depends on the exact cell phone model, but it will be understood that other types of memory with varying size could be used without departing from the spirit of the invention. It will be further recognized that data types other than cell phone phonebook records could be supported by memory 178 without departing from the spirit of the invention. By way of example, but not meant as a limitation, such data as photos, music files or text files could be supported for use with compatible cell phones.

In this way a user may reuse the main body of the apparatus 100 even when changing manufacturers or models. If the user's new phone is not compatible with the Cell Phone connector 175, he or she may simply purchase a new MAA 170 thereby significantly reducing the cost. Cover 180 is easily removed and replaced and performs the same function in the same manner as cover 150 discussed above.

From the preceding discussions it can be seen that a first advantage of the present invention is the ability of a user to transfer data from and to a cell phone. Thus if the user wishes to change to a new phone, the data stored on the previous phone may be saved and transferred relieving the user of the need to reenter the data.

A second advantage of the present invention is the ability to backup the data stored in a cell phone to the apparatus of the present invention. Once stored within the memory of the apparatus of the present invention the user may simply leave it there for backup or, if desired, transfer the data to a PC for further manipulation.

A third advantage of the present invention is the ability of a user to edit the contents of a cell phone memory in a user friendly data editing environment. Such an environment in a preferred embodiment is a PC. Having this ability allows the addition, deletion or modification of cell phone data without the clumsy and difficult mechanism provided by the limited function of the keypads of cell phones.

A fourth advantage of the present invention is the auto download upon launch of the Edit function operating as part of the PC application. By accomplishing the transfer of data from the apparatus of the present invention to the temporary program memory of the PC resident application program, the data automatically populate the user screen making the operation efficient and user friendly.

A fifth advantage of the present invention is the ability to transfer the contents of a cell phone memory without the use of a PC or other external digital device. The transfer may be accommodated in a number of ways including IDTP to IDTP, from one cell phone to a different cell phone using only one IDTP, or cell phone to cell phone using compatible IDTPs. Alternate embodiments allow for power to be delivered from a standard AC source or from a cell phone.

A sixth advantage of the present invention is the use of detachable characteristic modules that adapt the IDTP to different manufactures and models of cell phones. By doing this the user achieves an economic benefit in that only one IDTP need be purchased to accommodate a plurality of cell phones.

A seventh advantage of the present invention is the ability of the application software program running on the user's PC to determine compatibility of newer cell phones by reviewing the data captured by the apparatus of the present invention from the current cell phone of the user. By so doing the user of the present invention is constantly able to keep up to date with the most current cell phone technology available.

An eighth advantage of the present invention is the ability to keep the user's IDTP and PC resident application software up to date. This is accomplished by tracking user data saved in the memory of the IDTP. As bugs are resolved and/or newer functions added the user can keep his/her device up to date without the expense of purchasing a newer IDTP.

A ninth advantage of the present invention is the ability to support a broad spectrum of data types such as photos, music files, ring tones and text messages. Having this ability allows users to take maximum advantage of their cell phone's capabilities.

A tenth advantage of the present invention is the absence of a need for the user to load special interface drivers to their PC. Since the O/S of the IDTP contains its own USB driver, the user simply plugs the IDTP in and proper protocols are established.

1. A method for bidirectional transfer of data contained in a first external device memory to a second external device memory for backup, update, transfer, edit or upgrade, the method comprising:
attaching a low complexity digital device to a first external device, said first external device providing operational power to said low complexity digital device;
choosing an operational interface from among a plurality of operational interfaces supported by said low complexity digital device, said operational interface being automatically chosen to be compatible with said first external device;
selecting one of a plurality of data actions associated with said first external device, said selection occurring by selecting one of a plurality of user inputs compatible with said chosen operational interface;
monitoring said low complexity digital device to determine when said selected one of said data actions associated with said first external device is successful, the selected one of the data actions resulting in a transfer of data from the first external device to the low complexity digital device;
detaching said low complexity digital device from said first external device;
reattaching said low complexity digital device to a second external device, said second external device providing power to said low complexity digital device;
re-choosing an operational interface from among a plurality of operational interfaces supported by said low complexity digital device, said operational interface being automatically chosen to be compatible with said second external device;
reselecting one of a plurality of data actions associated with said second external device, said selection occurring by selecting one of a plurality of user inputs compatible with said chosen operational interface;
interacting with said second external device to complete said selected data actions associated with said second external device, the selected one of the data actions resulting in a manipulation of data associated with the first external device, and results of the manipulation affecting the data associated with the first external device that is stored on the low complexity digital device;
re-detaching said low complexity digital device from said second external device;
reattaching said low complexity digital device to said first external device;
re-choosing an operational interface from among a plurality of operational interfaces supported by said low complexity digital device, said operational interface being automatically chosen to be compatible with said first external device;
reselecting one of a plurality of data actions associated with said first external device, said selection occurring by selecting one of a plurality of user inputs compatible with said chosen operational interface;
re-monitoring said low complexity digital device to determine when said selected one of said data actions associated with said first external device is successful, the selected one of the data actions resulting in a transfer of data from the low complexity digital device to the first external device, the data transferred from the low complexity digital device being the data that was associated with the first external device and that was affected by the manipulation, and;
re-detaching said low complexity digital device from said first external device;
the plurality of data actions includes at least merge and upgrade.

2. The method of claim 1 where the first external device is a cellular telephone.

3. The method of claim 1 where the second external device is a personal computer.

4. The method of claim 1 where the operational interface automatically chosen for the low complexity digital device is one of either universal serial bus or universal asynchronous receiver/transmitter.

5. The method of claim 1 where the operational interface automatically chosen for the second external digital device is universal serial bus.

6. The method of claim 1 where the plurality of data actions include at least backup, update, transfer, and edit.

7. A method for bidirectional transfer of data contained in a first external device memory to a second external device memory for backup, update, transfer, edit or upgrade, the method comprising:
attaching a low complexity digital device to a first external device, said first external device providing operational power to said low complexity digital device;
choosing an operational interface from among a plurality of operational interfaces supported by said low complexity digital device, said operational interface being automatically chosen to be compatible with said first external device;
selecting one of a plurality of data actions associated with said first external device, said selection occurring by selecting one of a plurality of user inputs compatible with said chosen operational interface;
monitoring said low complexity digital device to determine when said selected one of said data actions associated with said first external device is successful, the selected one of the data actions resulting in a transfer of data from the first external device to the low complexity digital device;
detaching said low complexity digital device from said first external device;
reattaching said low complexity digital device to a second external device, said second external device providing power to said low complexity digital device;
re-choosing an operational interface from among a plurality of operational interfaces supported by said low complexity digital device, said operational interface being automatically chosen to be compatible with said second external device;
reselecting one of a plurality of data actions associated with said second external device, said selection occurring by selecting one of a plurality of user inputs compatible with said chosen operational interface; and
interacting with said second external device to complete said selected data actions associated with said second external device, the selected one of the data actions resulting in a manipulation of data associated with the first external device;
the plurality of data actions includes at least merge and upgrade.

8. The method of claim 7 where both the first and the second external devices are cell phones.

9. The method of claim 7 where the operational interface automatically chosen for the external digital device is universal asynchronous receiver/transmitter.

10. The method of claim 7 where the plurality of data actions includes at least either backup, update, transfer, and edit.

11. A method for bidirectional transfer of data contained in a first external device memory to a second external device memory for backup, update, or transfer, the method comprising:
attaching a first low complexity digital device to a first external device;
attaching a second low complexity digital device to a second external device;
connecting said first low complexity digital device to said second low complexity digital device by means of an external cable;
choosing a first operational interface from among a plurality of operational interfaces supported by said first low complexity digital device, said first operational interface being automatically chosen to be compatible with said first external device;
choosing a second operational interface from among a plurality of operational interfaces supported by said second low complexity digital device, said second operational interface being automatically chosen to be compatible with said second external device;
selecting one of a plurality of data actions associated with said first and said second external devices, said selection occurring by selecting means compatible with said chosen operational interface;
monitoring said first and said second low complexity digital devices to determine when said selected one of said data actions associated with said first and said second external devices is successful, and;
detaching said first and said second low complexity digital devices from said first and said second external device.

12. The method of claim 11 where the first and second external devices are cellular telephones.

13. The method of claim 11 where the operational interface automatically chosen for the first and second low complexity digital devices is one of either universal serial bus or universal asynchronous receiver/transmitter.

14. The method of claim 11 where the data action taken is selected from a plurality of data actions including at least merge.

15. The method of claim 11 where both the first and the second low complexity digital devices receive power from the first and second external devices respectively.

16. The method of claim 11 where both the first and the second low complexity digital devices receive power from an external power source.

17. The method of claim 11 where the selecting means is a switch located on one of either the first or second low complexity digital devices.

18. The method of claim 11 where the selecting means is a switch located on the external cable connecting the first and second low complexity digital devices.

19. An method for maintaining compatibility of a low complexity digital device, the method comprising:
attaching a low complexity digital device to an external device, said external device providing operational power to said low complexity digital device;
launching an application program resident on said external device, said application program providing a plurality of data manipulation tasks associated with said low complexity digital device, said data manipulation tasks denominated as tabs;
selecting one of said tabs, said selection occurring by selecting means compatible with said application program;
monitoring execution of said application program to determine when said selected one of said data manipulation tasks is successful;
providing messages relevant to said monitoring of said selected one of said data manipulation-tasks;
suspending operation of said selected one of said data manipulation tasks when said selected one of said data manipulation tasks has completed;
waiting for input from an operator, and;
placing said application program in an inactive mode when said operator detaches said low complexity digital device from said external device.

20. The method of claim 19 where the data manipulation tasks may be selected from among at least edit, transfer, check for compatible phones, check for updates and help and support.

21. The method of claim 20 where the edit data manipulation task is further comprised of selectable commands of at least save, add, edit, delete, and print.

22. The method of claim 20 where the check for updates data manipulation task is further comprised of updating firmware or updating application software.

23. The method of claim 19 where the external device is a PC.

24. The method of claim 19 where the external device is a PDA.

25. The method claim 19 wherein said application program is menu driven.

26. The method of claim 19 wherein the application program is Windows™ operating system compatible.

27. A system for bidirectional transfer of data contained in a first external device memory to a second external digital device memory for backup, update or transfer, the apparatus comprising:
a plurality of interchangeable manufacturers' attribute adapters, each of the plurality of manufacturers' attribute adapters corresponding to one of a plurality of cellular phones, each of the plurality of manufacturer's attribute adaptors corresponding to a different one of the plurality of cellular phones, each of the manufacturers' attribute adaptors providing a mechanical and an electrical interface between a low complexity digital device and the type of cellular telephone that corresponds to the manufacturer's attribute adapter;
the low complexity digital device including at least:
a central processing unit (CPU);
a memory;
at least two input/output ports, said input/output ports further comprised of:
a first input/output port configured to provide interface signals for both universal asynchronous serial data transfer and manufacturers' proprietary serial data transfer, said first input/output port capable of accepting each of the plurality of interchangeable manufacturers' attribute adapters;
a second input/output port configured to provide interface signals for universal serial bus (USB) data transfers wherein each of said first and said second input/output ports has the capability of providing power to said low complexity digital device upon connection of either of said first or second input/output port;
at least two user indicators, said user indicators functioning to alert a user to the status of a data transfer process;
a resident software program in said memory of said low complexity digital device, said resident software program further comprised of:
an operating system, said operating system further comprised of an embedded USB driver;
a compatibility module capable of automatically determining the hardware and software status of an external digital device, the compatibility module checking for a model number and manufacturer's code to determine compatibility, and;
a data transfer module capable of transferring data to and from said external digital device to said memory of said low complexity digital device.

28. The apparatus of claim 27 where the operating system is UC/OS-II™.

29. The apparatus of claim 27 wherein each of the plurality of manufacturers' attribute adaptor is external to but still forming a part of the low complexity digital device such that said low complexity digital device may be used with the plurality of said manufacturers' attribute adaptors.

30. The apparatus of claim 29 wherein said manufacturer's attribute adapter contains a memory.

31. The apparatus of claim 27 wherein the first and second external digital devices are cell phones, and the resident program containing machine instructions that transfer data from one of the cell phones to another of the cell phones without need for receiving instructions from another external device.

32. A system for transferring, manipulating and updating data associated with a low powered digital device, said low powered digital device used to operate on data contained in the memory of a cell phone comprised of:
an external digital device, said external digital device including at least a computer readable medium storing an an application program, the application program including at least machine instructions, which when implemented cause a processor to communicate with a server via a network, download data from the server to the external device, and pass the data to and from a low powered digital device;
a network; and;
a low powered digital device, said low powered digital device further comprising:
an operating system, said operating system further comprised of an embedded USB-driver;
a compatibility module capable of automatically determining the hardware and software status of a cell phone, and;
a data transfer module capable of transferring data to and from an external digital device to said memory of low complexity digital device.

33. The system of claim 32, wherein said external digital device is a PC.

34. The system of claim 32, wherein said external digital device is a PDA.

35. The system of claim 32 wherein the data is software code.

36. The system of claim 32 wherein the data is firmware code.

37. The system of claim 32, wherein the application program including at least machine instructions, which when implemented cause a processor to transfer cell phone records between the low complexity digital device and the external device, said cell phone records including at least text, numerical, and graphical data are transferred.

38. The network of claim 31 wherein the network is the Internet.

39. The method of claim 19, the monitoring comprising:
automatically determining a maximum acceptable time for transferring a set of data;
automatically checking the timer to determine whether a transfer of the set of data has taken longer than the maximum acceptable time for transferring the set of data.

40. The method of claim 19, the monitoring comprising:
automatically checking a timer to determine whether a transfer of a record has taken longer than is acceptable.

41. The method of claim 19, the monitoring comprising:
automatically checking a timer to determine whether a writing of a record has taken longer than is acceptable.

42. The method of claim 19, the monitoring comprising:
automatically determining a maximum acceptable time for transferring a set of data;
automatically checking a first timer to determine whether the transferring of the set of data has taken longer than the maximum acceptable time for transferring the set of data, if the checking of the first timer determines that the transferring of the set of data is taking longer than the maximum acceptable time for transferring the set of data terminating the transfer of the set of data and indicating an error;
automatically checking a second timer to determine whether a transfer of a current record has taken longer than is acceptable, if the checking of the second timer determines that the transferring of the current record is taking longer than the maximum acceptable time for transferring the current record, terminating the transfer of the set of data and indicating an error;
automatically checking a third timer to determine whether a writing of a current record has taken longer than is acceptable, if the checking of the third timer determines that the writing of the current record is taking longer than the maximum acceptable time for writing the current record, terminating the transfer of the set of data and indicating an error;
resetting the second timer after the record was transferred;
resetting the third timer after the record is written;
repeating the checking of the first time, the checking of the second timer, the resetting of the second time, the checking of the third timer, and the resetting of the third timer for each record of the set of data, unless the transferring of the data is terminated as a result of checking one of the first timer, the second timer, or the third timer prior to completing the transferring of the set of data, and recites when the clocks are reset.

43. The system of claim 27, the low complexity device being an Inter-Device Transfer Processor (IDTP), the system further comprising a computer readable medium storing thereon machine readable instructions, which when implemented, causes a processor to implement a method comprising:
transferring data between a cell phone and the IDTP;
transferring data between the IDTP and an external device having external personal information management software; and
synchronizing data between a cellular phone and information managed by external personal information management software.

44. The system of claims 27, the memory including at least data memory that stores phone book data, holding data from a cellular phone.

45. The system of claim 43, further comprising a personal computer having a processor for implementing the method the computer readable medium that stores the method, where the external device is the personal computer.

46. The system of claim 27, the CPU memory including a manufacturer code table, and machine instructions, which when implemented causes the CPU to implement a method comprising:
comparing a code in a cellular phone to the manufacturer code table;
determining whether the cellular phone is supported by the IDTP based on the comparison; and
terminating the method if the determining determines that the phone is not supported by the IDTP.

47. The system of claim 27, the memory further including at least Synchronous Dynamic Random Access Memory (SDRAM), which stores system data structure, buffers, and queues.

48. The system of claim 27, the memory further including at least a portion that stores system data and structure, buffers, and queues;
the system data and structures including at least
a first variable,
second variable, and
a third variable;
the first variable storing a state of an indicator that indicates whether a status of a data transfer;
the second variable storing an indication of whether a model number of a cellular phone was detected; and
the third variable storing a cell phone serial number.

49. A system including at least a computer readable medium storing a one or more machine instructions, which when invoked, cause a processor to implement a method comprising:
establishing a connection to a server via a network;
requesting information about updates to software related to an Inter-Device Transfer Processor (IDTP);
receiving the information; and
in response, downloading updates to the software related to the IDTP;
the IDTP being a low complexity device including at least
a plurality of interchangeable manufacturers' attribute adapters, each of the plurality of manufacturers' attribute adapters corresponding to one of a plurality of cellular phones, each of the plurality of manufacturer's attribute adaptors corresponding to a different one of the plurality of cellular phones, each of the manufacturers' attribute adaptors providing a mechanical and an electrical interface between a low complexity digital device and the type of cellular telephone that corresponds to the manufacturer's attribute adapter;
the low complexity digital device including at least:
a central processing unit (CPU);
a memory;
at least two input/output ports;
a first input/output port configured to provide interface signals for a target device;
a second input/output port configured to provide interface for an external device;
at least two user indicators, said user indicators functioning to alert a user to the status of a data transfer process;
a resident software program in said memory of said low complexity digital device, said resident software program for transferring data to and from said external digital device to said memory of the IDTP.

50. A system comprising:
an adapter that has a custom connection characteristic to a plurality of target cell phones, the adapter forming the second of the two input/output ports;
a first interface forming a first of the two input/output ports; and
a second of the two input output ports having a second interface to the adapter and a third interface connected to the adaptor;
the cell phone I/O passes signals between the CPU and the adapter;
the second interface passes signals between the CPU and the adapter;
the CPU memory storing one or more machine instructions, which when implemented, causes the CPU to determine whether the second interface has been connected to another device or whether the third interface is connected to another device;
a compatibility module capable of automatically determining the hardware and software status of an external digital device, the compatibility module checking for a model number and manufacturer's code to determine compatibility, and;
a data transfer module capable of transferring data to and from said external digital device to said memory of said low complexity digital device. and
the memory storing at least machine one instruction, which when implemented causes the CPU to determine whether the second interface is in use or the third interface is in use.

51. The system of claim 43, the low complexity device being an IDTP, the computer readable medium also storing machine instructions, which when implemented, cause a processor to implement a method comprising:
establishing a connection to a server via a network;
requesting information about updates to software related to the IDTP;
receiving the information; and
in response, downloading updates to the software related to the IDTP.

52. The system of claim 49, the computer readable medium storing at least machine instructions which when implemented cause a processor to implement a method comprising:
fetching current data, the current data including at least Previous Cell Phone (PCP), Current cell Phone (CCP), Firmware (FW) revision, and Service Pack (SP) for the IDTP;
determining whether there was a PCP;
if the determining of whether there was a PCP determines that there was no PCP, determining whether the PCP and the CCP are supported;
if the determining of whether the PCP and CCP are supported determines that the PCP and CCP are supported, writing a PCP field and a CCP field;
if the determining of whether the PCP and CCP are supported determines that the PCP and CCP are not supported, displaying a user message indicating which cell phones are supported;
if the determining of whether there was a PCP determines that there was a PCP, determining whether the PCP is the CCP,
if the determining of whether the PCP is the CCP determines that the PCP was not the CCP, the method proceeds to the determining of whether the PCP and CCP are supported;
if the determining of whether the PCP is the CCP determines that the PCP is the CCP, writing the CCP to a field;
selecting a model;
determining whether the FW revision and SP are supported;
if the determining of whether the FW revision and SP are supported determines that the FW revision or the SP are not supported, performing an upgrade process;
if the determining of whether the FW revision and SP are, supported determines that the FW revision and SP are supported, determining whether the FW revision and the SP are up-to-date;
if the determining of whether the FW revision and SP are up-to-date determines that the FW revision or the SP are not up-to-date, determining whether the user wants to update the FW revision or the SP;
if the determining of whether the user wants to update the FW revision or the SP determines that the user wants to update the FW revision or the SP,
fetching the current FW revision or SP,
downloading the FW revision or SP, and
displaying a selection of inputs for the user to choose from;
if the determining of whether the user wants to update the FW revision or the SP determines that the user does not want to update the FW revision or the SP, displaying the selection of inputs for the user to choose from; and
if the determining of whether the FW revision and SP are up-to-date determines that the FW revision or the SP are up-to-date,
displaying the selection of inputs for the user to choose from.

53. The system of claim 49, the computer readable medium storing at least machine instructions which when implemented cause a processor to implement a method comprising:
the user selecting an input for performing an update process,
performing the update process, the update process including at least:
fetching at least the software version, firmware revision, and editing software version;
determining whether the software version, and edit software version are old;
if the determining whether the software version and edit software version are old, determines that the software version or edit software version are old, downloading an up-to-date version of the software version and edit software version;
if the determining whether the software version and edit software version are old, determines that the software version or edit software version are not old, determining whether the firmware version is old;
if the determining whether the firmware process is old, determines that the firmware version is old, downloading an up-to-date firmware version;
if the determining whether the firmware process is old, determines that the firmware version is not old, displaying a message indicating that the IDTP and application program running on a PC are up-to-date; and
after performing the update process, displaying a choice of user input for the user to choose from.

54. The system of claim 49, the computer readable medium storing at least machine instructions which when implemented cause a processor to implement a method comprising:
displaying a plurality of user input to select from on a display;
the user selecting from the plurality of user input, an input for performing an edit process, the edit process including at least:
determining whether data is present on the IDTP;
if the determining of whether the data is present determines that no data is present on the IDTP, displaying a message requesting that data be saved to the IDTP;
if the determining of whether the data is present determines that data is present on the IDTP,
opening a data file having the data,
performing a user edit session in which the user is allowed to edit the data,
determining whether the user wants to exit the edit process;
if the determining whether the user wants to exit the edit process determines that determines that the user does not want to exit the edit process, determining whether the user wants to perform a save process,
if the determining whether the user wants to exit the edit process determines that determines that the user wants to exit the edit process, determining whether any changes to the data occurred,
if the determining of whether any changes to the data occurred, determines that a change to the data did not occur, displaying the plurality of input options;
if the determining of whether any changes to the data occurred, determines that a change to the data occurred, determining whether the user wants to perform the save process to save the data,
if the determining of whether the user wants to save the data, determines that the user wants to save the data, performing the save process, and
if the determining of whether the user wants to save the data, determines that the user does not want to save the data, displaying the plurality of input options.

55. The system of claim 49, the computer readable medium storing at least machine instructions which when implemented cause a processor to implement a method comprising:
performing an edit process, as a result of performing the edit process determining that the user would like to perform a save process,
as a result of determining that the user would like to perform the save process, performing the save process, the save process including at least:
determining whether an IDTP is plugged into an external device;
if the determining of whether an IDTP is plugged into the external device determines that no IDTP is plugged into the external device, displaying a message requesting to plug in the IDTP and repeating the determining of whether an IDTP is plugged into an external device;
if the determining of whether an IDTP is plugged into the external device determines that the IDTP is plugged into the external device, determining whether the model and manufacturer of a cell phone associated with data stored in the IDTP are valid;
if the determining of whether the model and manufacturer of the cell phone associated with the data stored in the IDTP are valid determines that the model and manufacturer are valid, writing the data to the IDTP;
if the determining of whether the model and manufacturer of the cell phone associated with the data stored in the IDTP are valid determines that the model or manufacturer are not valid, displaying a message about the not valid result and determining whether the user wants to save the data despite the not valid result;
if the determining of whether the user wants to save the data despite the not valid result, determines that he user wants to save the data despite the not valid result, performing the writing of the data to the IDTP;
if the determining of whether the user wants to save the data despite the not valid result, determines that he user does not wants to save the data, displaying a plurality of user input to select from on the display; and
after performing the writing of the data to the IDTP, displaying the plurality of user input to select from on the display.

56. The system of claim 49, the memory storing at least machine instructions which when implemented cause a processor to implement a method comprising:
the user selecting from the plurality of user input, an input for performing a transfer process,
performing the transfer process, the transfer process including at least:
downloading memory of a source IDTP to an external device;
determining whether the downloading of the memory of the source IDTP is finished, if the downloading is not finished, continuing the downloading of the memory of the source IDPT;
if the downloading of the memory of the source IDTP is finished, displaying message on the external device to connect a target IDTP;
determining whether a target IDTP is plugged into the external device;
if the target IDTP is not plugged into the external device, returning to the displaying of the message to connect the target IDTP;
if the target IDTP is plugged in to the external device, transferring data to the target IDTP, the data being information that was downloaded from the memory of a source IDTP to an external device;
determining whether the transferring of the data to the target IDTP is finished, if the transferring is not finished, continuing the transferring of the memory of the source IDPT;
if the transferring of data is finished, displaying a message on the external device that the data may now be transferred from the target IDTP to a target cell phone.

57. The system of claim 49, the memory storing at least machine instructions which when implemented cause a processor to implement a method comprising:
displaying a plurality of user input to select from on a display;
the user selecting from the plurality of user input, an input for performing a compatible phone process for checking for compatible phones, the compatible phone process including at least:
displaying a list of compatible phones;
displaying a message to add a new phone;
determining whether the user wants to add a phone to the compatible phones;
if the determining of whether the user wants to add a phone to the compatible phones, determines that the user wants to add a phone, performing an update process; and
if the determining of whether the user wants to add a phone to the compatible phones, determines that the user does not want to add a phone, displaying the plurality of user inputs.

58. The system of claim 49, the memory storing at least machine instructions which when implemented cause a processor to implement a method comprising:
displaying a plurality of user input to select from on a display;
the user selecting from the plurality of user input, an input for performing a help process, performing the help process, the help process including at least:
determining whether the user wants to view frequently asked questions;
if the determining of whether the user wants to view the frequently asked questions determines that the user wants to view frequently asked questions, displaying frequently asked questions;
if the determining of whether the user wants to view the frequently asked questions determines that the user does not want to view the frequently asked questions, determining whether the user wants online support,
if the determining of whether the user wants to the online support determines that the user wants the online support, establishing an internet connection for the online support;
if the determining of whether the online support determines that the user does not want online support, determining whether the user would like to uninstall the application from the external device,
if the determining of whether the user wants to the uninstall the application determines that the user wants to uninstall the application, uninstalling the application;
if the determining of whether the user wants to the uninstall the application that the user does not want uninstall the application, displaying the plurality of user input options.

59. The system of claim 49, further comprising: an external device having the computer readable medium and the IDTP, the memory storing at least machine instructions, which when implemented, cause a processor to implement a method comprising:
the IDTP detecting power from a USB port of an external device;
the IDTP performing a power up routine;
the method launching an application on the external device;
the application program determining whether the IDTP is still plugged into the third port;
if the application program determines that the IDTP in not plugged into the third port, external device displaying a message requesting that an IDTP be plugged into the external device;
if the application program determines that the IDTP is plugged in to the external device, fetching an electronic serial number identifying the IDTP,
fetching a link string data record, the link string data record including at least
a Previous Cell Phone,
a Current Cell Phone,
a Service Pack,
a revision level of current firmware, and
a revision level of current hardware, and
one or more fetching error codes, each error code including at least an identification of an occurrence of an error and an identification of a type of error that occurred; and
displaying a plurality of user input options.

60. The method of claim 19, further comprising:
displaying a welcome screen including at least displaying multiple tabs, each tab causing screen associated with another task to be displayed, the multiple tabs including a tab for checking for the updates.

61. The method of claim 60, displaying the welcome screen including at least displaying
a tab for editing the data;
a tab for checking compatible phones;
a tab for checking for updates;
a tab for transferring a phonebook; and
a tab for help.

62. The system of claim 60, the method further comprising:
receiving user input causing the tab for checking for compatible phones to be activated, which causes a screen to be displayed showing a list of compatible phones, and presenting an option to add another phone to the list of compatible phones.

63. The system of claim 50, the memory storing at least:
an Electronic Serial Number, which is unique to the IDTP; and
a link string data record, including at least
a Previous Cell Phone,
a Current Cell Phone,
a Service Pack,
a revision level of current firmware, and
a revision level of current hardware.

64. The system of claim 50, the memory storing a plurality of error codes, each error code being associated with a different type of error.

65. The system of claim 50, the memory storing at least machine instructions which when implemented cause a processor to implement at least
determining that an error occurred;
assigning an error code to the error that occurred; and
storing the error code in association with the error that occurred.

66. The system of claim 49, the computer readable medium storing at least machine instructions which when implemented cause a processor to implement a method comprising:
receiving user input for adding a phone;
in response, sending a request to a server to add a new phone; and
in response, receiving a manufacturer's code for the new phone.

67. The method of claim 19, further comprising:
detecting a code in an attached cell phone;
comparing the code to table stored in the IDTP;
determining whether the code is valid based on the comparing;
if a determining determines that the code is not valid, returning to performing CPU internal test;
if a determining determines that the code is valid, initializing process variables and program counters;
determining whether the IDTP is unplugged;
if the IDTP is unplugged, returning to performing the CPU internal test;
if the IDTP is not unplugged, determining whether a button is pushed;
if the IDTP determines that the button is not pushed, returning to determining whether the IDTP is unplugged;
if the IDTP determines that the button is pushed, performing a delay; and
determining whether an update or backup is initialized.

68. A system comprising:
a first connector connected to one end of a cable;
a second connector connected to a second end of the cable;
a switch mechanism in the cable, the switch mechanism determining whether data is transferred from a first Inter-device Data Transfer Processor (IDTP) attached to the first connector to a second IDTP connected to the second connector; and
a power supply electrically connected to the cable, the power supply supplying sufficient power for powering the first IDTP and the second IDTP.

69. The system of claim 68, the switch mechanism including at least two buttons, a first of the two buttons causing data to be transferred from the first IDTP to the second IDTP, and a second of the two buttons causing data to flow from the second IDTP to the first IDTP.

70. The system of claim 68, the switch mechanism including at least a sliding member having at least three positions,
a first the three positions causing data to be transferred from the first IDTP to the second IDTP,
a second of the at least two positions causing data to flow from the second IDTP to the first IDTP, and
a third position in which data is not transferred between the first IDTP and the second IDTP.

71. The system of claim 39 further comprising:
the first IDTP and second IDTP;
the first IDTP being powered by the power supply and not having another power source; and
the second IDTP being powered by the power supply and not having another power source.

72. A system comprising:
a low complexity digital device including at least an Inter-Device Transfer Processor (IDTP), the IDTP comprising:
a central processing unit (CPU);
a memory;
user controls,
two input/output ports,
a first of said two input/output ports being a device input/output that is configured to accommodate a target digital device interface connection,
a second of said two input/output ports being cell phone input/output port that is configured to accept one of a plurality of manufacturer's characteristic adapters said manufacturer's characteristic adapters providing mechanical and electrical interface between said non-powered low complexity digital device and a cellular telephone; and
a resident software program in said memory of said low complexity digital device, said resident software program including one or more instructions that cause a transferring of data from a cellular telephone to said memory of the low complexity digital device, the one or more instructions causing the transferring of data from the cellular telephone cause the transferring to occur via said second input/output port in response to a user activation of functions provided by said resident software program; and
the IDTP stores program instructions that, when implemented, cause a transfer data to the IDTP from a second IDTP or from the IDTP to the second IDTP, whether while implementing the program instructions the IDTP becomes a master to the other IDTP or becomes a slave to the other IDTP, depends on whether the program instructions were activated by the user controls of the IDTP, which results in the IDTP being the master and the other IDTP being the slave, or whether the program instructions were activated by user controls of the other IDTP, which results in the IDTP being the slave and the other IDTP being the master.

73. The system of claim 72 further comprising:
the second IDTP; and
a cable having
a first end and a second end,
a first connector connected to the first end of the cable, the first connector being removably connected to the IDTP, and
a second connector connected to the second end of the cable, the second connector being removably connected to the other IDTP.
